(19) United States
(12) Patent Application Publication
(10) Pub. No.: US 2013/0207037 A1
(43) Pub. Date: Aug. 15, 2013

(54) Water-Absorbing Polymeric Particles and Method for the Production Thereof

(71) Applicants: Thomas Daniel, Waldsee (DE); Yvonne Hagen, Waldsee (DE); Ulrich Riegel, Landstuhl (DE); Dieter Hermeling, Bohl-Iggel-Heim (DE); Stefan Bruhns, Hellerup (DK)

(72) Inventors: Thomas Daniel, Waldsee (DE); Yvonne Hagen, Waldsee (DE); Ulrich Riegel, Landstuhl (DE); Dieter Hermeling, Bohl-Iggel-Heim (DE); Stefan Bruhns, Hellerup (DK)

(73) Assignee: BASF SE, Ludwigshafen (DE)

(21) Appl. No.: 13/880,205

(22) PCT Filed: Oct. 14, 2011
(86) PCT No.: PCT/EP11/68014

§ 371 Date: Apr. 18, 2013

Related U.S. Application Data
(60) Provisional application No. 61/405,274, filed on Oct. 21, 2010.

(51) Int. Cl. B01J 20/26

(52) U.S. Cl. CPC B01J 20/267
USPC 252/194; 525/55; 525/340

(57) ABSTRACT

The present invention relates to a water-absorbing material obtainable by a process comprising the steps of: a) obtaining, optionally coated, post-crosslinked water-absorbing polymeric particles; b) exposing said particles of step a) to a vacuum-treatment, at a pressure of from 0.0001 mbar to 700 mbar; and c) optionally exposing said particles of step b) to a plasma-treatment, and processes for their production.

The present invention concerns water-absorbing polymeric particles obtainable by treatment of a water-absorbing base polymer with at least one postcrosslinker and treating the postcrosslinked polymer under a vacuum, processes for their production and also their use in hygiene articles and packaging materials.

Water-absorbing polymeric particles are known. The most widely used common name for such materials is “superabsorbents”. Superabsorbents are materials that are able to take up and retain several times their weight in water, possibly up to several hundred times their weight, even under moderate pressure. Absorbing capacity is usually lower for salt-containing solutions compared to distilled or otherwise de-ionised water. Typically, a superabsorbent has a centrifugal retention capacity (“CRC”, method of measurement see below) of at least 5 g/g, preferably at least 10 g/g and more preferably at least 15 g/g. Such materials are also commonly known by designations such as “highswellability polymer”, “hydrogel” (often even used for the dry form), “hydrogel-forming polymer”, “water-absorbing polymer”, “absorbent gel-forming material”, “swellable resin”, “water-absorbing resin” or the like. The materials in question are crosslinked hydrophilic polymers, in particular polymers formed from (co)polymerized hydrophilic monomers, graft (co)polymers of one or more hydrophilic monomers on a suitable grafting base, crosslinked ethers of cellulose or starch, crosslinked carboxymethylcellulose, partially crosslinked polyalkylene oxide or natural products that are swellable in aqueous fluids, examples being guar derivatives, of which water-absorbing polymers based on partially neutralized acrylic acid are most widely used. Superabsorbents are usually produced, stored, transported and processed in the form of dry powders of polymer particles, “dry” usually meaning less than 5 wt.-% water content (also called “moisture content”, method of measurement see below). A superabsorbent transforms into a gel on taking up a liquid, specifically into a hydrogel when as usual taking up an aqueous liquid. By far the most important field of use of superabsorbents is the absorbing of bodily fluids. Superabsorbents are used for example in hygiene articles such as diapers for infants, incontinence products for adults or feminine hygiene products. Examples of other fields of use are as water-retaining agents in market gardening, as water stores for protection against fire, for liquid absorption in food packaging or, in general, for absorbing moisture.

Processes for producing superabsorbents are also known. The acrylate-based superabsorbents which dominate the market are produced by radical polymerisation of acrylic acid in the presence of a crosslinking agent (the “internal crosslinker”), usually in the presence of water, the acrylic acid being neutralized to some degree in a neutralisation step conducted prior to or after polymerisation, or optionally partly prior to and partly after polymerisation, usually by adding a alkali, most often an aqueous sodium hydroxide solution. This yields a polymer gel which is comminuted (depending on the type of reactor used, comminution may be conducted concurrently with polymerisation) and dried. Usually, the dried powder thus produced (the “base polymer”) is surface crosslinked (also termed surface “post”crosslinked, or just “postcrosslinked”) by adding further organic or polyvalent metal (i.e. cationic) crosslinkers to generate a surface layer which is crosslinked to a higher degree than the particle bulk. Most often, aluminium sulphate is being used as polyvalent metal crosslinker. Applying polyvalent metal cations to superabsorbent particles is sometimes not regarded as surface crosslinking, but termed “surface complexing” or as another form of surface treatment, although it has the same effect of increasing the number of bonds between individual polymer strands at the particle surface and thus increases gel particle stiffness as organic surface crosslinkers have. Organic and polyvalent metal surface crosslinkers can be cumulatively applied, jointly or in any sequence. Any measures that have as their effect a higher crosslinking density near the particle surface than in the particle bulk serve the purpose of surface crosslinking. It is also known to achieve that by oxidatively destroying crosslinks in the particle bulk during drying by adding an oxidizing agent such as chlorate to the monomer solution. All of this is well known to an expert in this field.

Surface crosslinking leads to a higher crosslinking density close to the surface of each superabsorbent particle. This addresses the problem of “gel blocking”, which means that, with earlier types of superabsorbents, a liquid insult will cause swelling of the outermost layer of particles of a bulk of superabsorbent particles into a practically continuous gel layer, which effectively blocks transport of further amounts of liquid (such as a second insult) to unused superabsorbent below the gel layer. While this is a desired effect in some applications of superabsorbents (for example sealing underwater cables), it leads to undesirable effects when occurring in personal hygiene products. Increasing the stiffness of individual gel particles by surface crosslinking leads to open channels between the individual gel particles within the gel layer and thus facilitates liquids transport through the gel layer. Although surface crosslinking decreases the CRC or other parameters describing the total absorption capacity of a superabsorbent sample, it may well increase the total amount of liquid that can be absorbed by a hygiene product containing a given amount of superabsorbent during normal use of the product.

There is still a need to provide even thinner absorbent articles since they increase the wearing comfort. There has been a trend to remove part or all of the cellulose fibres (pulp) from the products. These ultrathin hygiene articles may comprise construction elements (for example—but not limited to—the diaper core or the acquisition distribution layer) which consist of water-absorbing polymeric particles to an extent which is in the range from 50% to 100% by weight, so that the polymeric particles in use not only perform the storage function for the fluid but also ensure active fluid transportation (in simple words, the capacity of a swollen gel bed to pull liquid against gravity, or wicking absorption, a property that can be quantified as Fixed Height Absorption (“FHA”) value, determined as described below) and passive fluid transportation (in simple words, the capacity of a swollen gel bed to allow flow of liquid with gravity, a property that can be quantified as Saline Flow Conductivity (“SFC”) value, determined as described below). The greater the proportion of cellulose pulp which is replaced by water-absorbing polymeric particles or synthetic fibers, the greater the number of transportation functions which the water-absorbing polymeric particles have to perform in addition to their storage function. It has been found that for such absorbent articles in particular, there is a need for water-absorbent polymeric particles that have a good absorbent capacity (CRC value) and a good fluid transportation (reflected by a good FHA value and SFC value). It is well-known in the art that there is a trade-off between the permeability of a superabsorbent and its capacity to absorb liquid (this capacity is also termed “absorbency”).

There have been some attempts to produce water-absorbing polymeric particles with a high Saline Flow Conductivity. WO 2005/014064 for example teaches to coat a waterswellable polymer with an elastomeric material.

The reduction of fluff in the diaper results in new fixation methods for water-absorbing polymeric particles. The particles are for example fixed by a fibrous thermoplastic material and/or adhesive material that is applied above or under the particles to give an absorbent structure.

It has been noticed that this type of fixation requires a sufficiently high wicking absorption (FHA) at least in the storage layer due to the fact cellulose fibers are either not present or used in very small amounts in these novel absorbent composite structures. Therefore it is one subject of the current invention to provide water absorbing particles which have a good FHA and a good SFC and do not lose it by the fixation to the nonwoven.

WO 2008/018009 teaches a water-absorbing material which is a mixture, especially a mixture of coated water-absorbing polymer particles and a material with radiationinduced hydrophilicity, like inorganic semiconductors for example TiO₂, SnO₂.

WO 03/080259 teaches a plasma modification of a water-absorbing polymer using argon or nitrogen gas which results in water-absorbing materials which have a higher resistant against salt poisoning. According to the example the commercial product ASAP 2000 (at the time produced by Chemdal Ltd., Birkenhead, UK and Chemdal Corp., Aberdeen Miss., USA) was treated as the water-absorbing material under vacuum with a nitrogen and/or argon plasma. ASAP 2000 is a water-absorbing polymeric material with a relatively low ability to transport fluids and its SFC is typically well below 50×10⁻⁷ cm³s/g.

The present invention therefore has for its object to provide water-absorbing polymeric particles having high passive fluid transportation (SFC) and sufficiently high initial uptake rates (a property that can be quantified as “free swell rate”, (“FSR”), value) and to not lose it due to the fixation to the nonwoven.

The present invention therefore has for its second object to provide water-absorbing polymeric particles having high passive fluid transportation (SFC) and high active fluid transportation (FHA) and sufficiently high initial uptake rates (FSR) and to not lose it by the fixation to the nonwoven.

The present invention therefore has for its third object to provide water-absorbing polymeric particles having high active fluid transportation (FHA) and sufficiently high initial uptake rates (FSR) and to not lose it by the fixation to the nonwoven.

The present invention has for its fourth objective to provide water-absorbing polymeric particles with good SFC, and good FHA and good FSR, and with the ability to satisfyingly withstand ageing of its absorption performance when incorporated into a water-absorbing composite structure according to the principles as described above.

The present invention has for its fifth objective to provide a process to make water-absorbing polymeric particles with good SFC, and good FSR and optionally good FHA which are useful to incorporate in water-absorbing composite structure according to the principles as described above.

We have found that this object is achieved by a method of producing water-absorbing particles comprising the steps of
a) obtaining, optionally coated, post-crosslinked water-absorbing polymeric particles
b) exposing said particles of step a) to a vacuum-treatment, at a pressure of from 0.0001 mbar to 700 mbar; and
c) optionally exposing said particles of step b) to a plasma-treatment.

We have found that this object is preferably achieved by a method of producing water-absorbing particles comprising the steps of
a) obtaining post-crosslinked water-absorbing polymeric particles which have a Centrifuge Retention Capacity (CRC) of at least 20 g/g, preferably of at least 25 g/g, for example at least 26 g/g or at least 27 g/g, and generally of up to 50 g/g, for example not more than 33 g/g, or not more than 30 g/g, and an Absorbency Under Load (AUL) of at least 15 g/g, preferably at least 19 g/g, most preferably at least 21 g/g, and a Saline Flow Conductivity (SFC) of at least ≧50×10⁻⁷ cm³s/g or at least 80×10⁻⁷ cm³s/g, preferably of at least 110×10⁻⁷ cm³s/g, and most preferably of at least 150×10⁻⁷ cm³s/g or at least 200×10⁻⁷ cm³s/g,
b) exposing said particles of step a) to a vacuum-treatment, at a pressure of from 0.0001 mbar to 700 mbar; and
c) optionally exposing said particles of step b) to a plasma-treatment.

We have further found that this object is achieved by a method of producing water-absorbing particles comprising the step of a plasma-treatment of post-crosslinked water-absorbing polymeric particles, preferably under ambient atmospheric pressure.

In a preferred embodiment the method of producing water-absorbing particles comprises the steps of vacuum-treatment and plasma treatment.

In a preferred embodiment the method of producing water-absorbing particles comprises the steps of vacuum-treatment and subsequent plasma treatment.

In a preferred embodiment the method of producing water-absorbing particles comprises the steps of plasma treatment and subsequent vacuum-treatment.

In a preferred embodiment the method of producing water-absorbing particles are concurrently vacuum-treated and plasma treated.

In one embodiment, said post-crosslinked water-absorbing polymeric particles may have a FHA of at least 8 g/g, or for example at least 10 g/g or at least 12 g/g or at least 15 g/g; in one embodiment, the post-crosslinked water-absorbing polymeric particles have a first FHA value and after vacuum and/or plasma treatment, said resulting surface modified post-crosslinked water-absorbing polymeric particles have a second FHA, and said second FHA is at least 10%, or at least 20%, or at least 30% more than said first FHA.

In a preferred embodiment the post-crosslinked water-absorbing polymeric particles are additionally surface modified with a film-forming polymer, or an elastic polymer or an elastic film-forming polymer, or any mixture thereof, as described herein.

In a preferred embodiment the method of producing water-absorbing particles comprises the step of vacuum-treatment without any plasma treatment.

In a preferred embodiment the post-crosslinked water-absorbing polymeric particles are additionally surface modified with a film forming polymer.

Post-crosslinked water-absorbing polymeric particles having a Centrifuge Retention Capacity (CRC) of at least 20, a AUL of at least 15, and a Saline Flow Conductivity (SFC) of at least 50×10⁻⁷ cm³s/g are known. In general their production comprises the treatment of a base water-absorbing polymer with a postcrosslinker and optional one or more additional surface modifying agents, and preferably at least one permeability enhancing agent.

The base water-absorbing polymer or base polymer

The base polymer is a superabsorbent prior to surface crosslinking.

The base polymer is typically produced by polymerization of a monomer solution comprising
i) at least one ethylenically unsaturated acid functional monomer,
ii) at least one ethylenically unsaturated crosslinker,
iii) optionally one or more ethylenically and/or allylically unsaturated monomers copolymerizable with i),
iv) optionally one or more water-soluble polymers grafted wholly or partly with the monomers i), ii) and optionally iii)
v) optionally in the presence of a non radical crosslinking agent, having in its single molecule two or more functional groups each of which allows formation of an ester or an amide bond by reaction with carboxyl groups.

The base polymer will typically be dried and classified after polymerization.

Useful monomers i) include for example ethylenically unsaturated carboxylic acids, such as acrylic acid, methacrylic acid, maleic acid, fumaric acid, and itaconic acid, or derivatives thereof, such as acrylamide, methacrylamide, acrylic esters and methacrylic esters. Acrylic acid and methacrylic acid are particularly preferred monomers. Acrylic acid is most preferable. In case acrylic acid and/or methacrylic acid is used as a component of the monomer-solution, it is preferred that these monomers prior to use have been stabilized with less than 250 ppm MEHQ, preferably less than 150 ppm MEHQ, more preferably less than 100 ppm MEHQ but more than 0 ppm MEHQ, and most preferably with 10-60 ppm M EHQ. MEHQ is the monomethylether of hydroquinone and is generally used for stabilization of acrylic acid.

The base polymer is internally crosslinked, i.e., the polymerization is carried out in the presence of compounds having two or more polymerizable groups which can be polymerized by a free-radical chain polymerization mechanism into the polymer network.

Useful crosslinkers ii) include for example ethylene glycol dimethacrylate, diethylene glycol diacrylate, allyl methacrylate, trimethylolpropane triacrylate, triallylamine, tetraallyloxyethane as described in EP-A 530 438, di- and triacrylates as described in EP-A 547 847, EP-A 559 476, EP-A 632 068, WO 93/21237, WO 03/104299, WO 03/104300, WO 03/104301 and in German patent application 103 31 450.4, mixed acrylates which, as well as acrylate groups, comprise further ethylenically unsaturated groups, as described in German patent applications 103 31 456.3 and 103 55 401.7, or crosslinker mixtures as described for example in DE-A 195 43 368, DE-A 196 46 484, WO 90/15830 and WO 02/32962.

Useful crosslinkers ii) include in particular N,N′-methylenebisacrylamide and N,N′-methylenebismethacrylamide, esters of unsaturated mono- or polycarboxylic acids of polyols, such as diacrylate or triacrylate, for example butanediol diacrylate, butanediol dimethacrylate, ethylene glycol diacrylate, ethylene glycol dimethacrylate and also trimethylolpropane triacrylate and allyl esters and vinyl esters of di-, tri- or polycarboxylic acids for example tartaric acid, citric acid, adipic acid like triallylcitrate and divinyladipate and allyl compounds, such as allyl (meth)acrylate, Wallyl cyanurate, diallyl maleate, polyallyl esters, tetraallyloxyethane, triallylamine, tetraallylethylenediamine, allyl esters of phosphoric acid and also vinylphosphonic acid derivatives as described for example in EP-A 343 427. Useful crosslinkers ii) further include pentaerythritol diallyl ether, pentaerythritol Wallyl ether, pentaerythritol tetraallyl ether, polyethylene glycol diallyl ether, ethylene glycol diallyl ether, glycerol diallyl ether, glycerol Wallyl ether, polyallyl ethers based on sorbitol, and also ethoxylated variants thereof. The process of the present invention utilizes di(meth)acrylates of polyethylene glycols, the polyethylene glycol used having a molecular weight between 300 and 1000.

However, particularly advantageous crosslinkers ii) are di- and triacrylates of altogether 3- to 15-tuply ethoxylated glycerol, of altogether 3- to 15-tuply ethoxylated trimethylolpropane, especially di- and triacrylates of altogether 3-tuply ethoxylated glycerol or of altogether 3-tuply ethoxylated trimethylolpropane, of 3-tuply propoxylated glycerol, of 3-tuply propoxylated trimethylolpropane, and also of altogether 3-tuply mixedly ethoxylated or propoxylated glycerol, of altogether 3-tuply mixedly ethoxylated or propoxylated trimethylolpropane, of altogether 15-tuply ethoxylated glycerol, of altogether 15-tuply ethoxylated trimethylolpropane, of altogether 40-tuply ethoxylated glycerol and also of altogether 40-tuply ethoxylated trimethylolpropane.

Very particularly preferred for use as crosslinkers ii) are diacrylated, dimethacrylated, triacrylated or trimethacrylated multiply ethoxylated and/or propoxylated glycerols as described for example in prior German patent application DE 103 19 462.2. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred. These are notable for particularly low residual levels (typically below 10 ppm) in the water-absorbing polymer and the aqueous extracts of water-absorbing polymers produced therewith have an almost unchanged surface tension compared with water at the same temperature, typically room temperature—(typically not less than 0.068 N/m).

Examples of ethylenically unsaturated monomers iii) which are copolymerizable with the monomers i) are acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

Useful water-soluble polymers iv) include polyvinyl alcohol, polyvinylpyrrolidone, starch, starch derivatives, polyglycols or polyacrylic acids, preferably polyvinyl alcohol and starch.

The preparation of a suitable water-absorbing polymer and also further useful hydrophilic ethylenically unsaturated monomers i) are described in DE-A 199 41 423, EP-A 686 650, WO 01/45758 and WO 03/104300.

The base polymers are internally crosslinked, the polymerization is carried out with at least one ethylenically unsaturated crosslinker ii) and optionally in the presence of a non radical crosslinking agent v), having in its single molecule two or more functional groups each of which allows formation of an ester or an amide bond by reaction with carboxyl groups. Useful non-radical crosslinking agents v) are described as “surface modifying agent—postcrosslinkers” vi) later on in this description, these can also be used as internal crosslinkers if added prior to or in the course of the polymerization step.

The reaction is preferably carried out in a kneader as described for example in WO 01/38402, or on a belt reactor as described for example in EP-A-955 086. Alternatively it can be carried out as reverse-suspension polymerization or as a dropletpolymerization in the gas phase.

The acid groups of the hydrogels obtained are preferably neutralized to a degree from 25 mol % to 90 mol %, preferably from 50 mol % to 80 mol %.

In one particular preferred embodiment the acid groups of the hydrogels obtained are preferably more than 60 mol %, more preferably more than 61 mol %, even more preferably more than 62 mol % and most preferably more than 63 mol % and preferably not more than 70 mol %, more preferably not more than 69 mol %, even more preferably not more than 68 mol % and most preferably not more than 67 mol % neutralized, for which the customary neutralizing agents can be used, for example ammonia, amines, such as ethanolamine, diethanolamine, triethanolamine or dimethylaminoethanolamine, preferably alkali metal hydroxides, alkali metal oxides, alkali metal carbonates or alkali metal bicarbonates and also mixtures thereof, in which case sodium and potassium are particularly preferred as alkali metals, but most preference is given to sodium hydroxyide, sodium carbonate or sodium bicarbonate and also mixtures thereof. Typically, neutralization is achieved by admixing the neutralizing agent as an aqueous solution or else preferably as a solid material.

Neutralization can be carried out prior to polymerization at the monomer stage, or after polymerization, at the hydrogel stage. But it is also possible to neutralize up to 40 mol %, preferably from 10 to 30 mol % and more preferably from 15 to 25 mol % of the acid groups before polymerization by adding a portion of the neutralizing agent to the monomer solution and to set the desired final degree of neutralization only after polymerization, at the hydrogel stage. The monomer solution may be neutralized by admixing the neutralizing agent, either to a predetermined degree of preneutralization with subsequent postneutralization to the final value after or during the polymerization reaction, or the monomer solution is directly adjusted to the final value by admixing the neutralizing agent before polymerization.

Optionally any chelating agents, known to a person skilled in the art, to mask transition metals may be added to the ready-to-react monomer solution, during its preparation or into any of its components prior to mixing. Suitable chelating agents are for example—but not limited to—alkali citrates, citric acid, alkali tartrates, tartaric acid, orthophosphoric acid and its alkali salts, pentasodium triphosphate, ethylendiaminetetraacetate, nitrilotriacetic acid, and all products under the Trilon® trademark of BASF SE, Ludwigshafen, for example pentasodium-diethylene-triaminepentaacetate: Trilon®C, Trisodium-(hydroxyethyl)-ethylene-diamine-triacetate: Trilon® D, and Methylglycinediacetic acid: Trilon M®. Alkali salts in this context are salts of Li, Na, K, Rb, Cs, and ammonium.

The hydrogel can be mechanically comminuted, for example by means of a meat grinder, in which case the neutralizing agent, if added after polymerization, can be sprayed, sprinkled or poured on and then carefully mixed in. To this end, the gel mass obtained can be repeatedly minced for homogenization. If the polymerization is carried out using apparatus that produces comminuted gel particles, such as a kneader, a separate hydrogel comminuting step may not be necessary.

A degree of neutralization which is too low may cause unwanted thermal crosslinking effects in the course of the subsequent drying and also during the subsequent post-crosslinking of the base polymer which are able to reduce the Centrifuge Retention Capacity (CRC) of the water-absorbing polymer substantially, to the point of inutility.

When the degree of neutralization is too high, however, postcrosslinking will be less efficient, which leads to a reduced Saline Flow Conductivity (SFC) on the part of the swollen hydrogel.

An optimum result is obtained when the degree of neutralization of the base polymer is adjusted such as to achieve efficient postcrosslinking and thus a high Saline Flow Conductivity (SFC) while at the same time neutralization is carried on sufficiently for the hydrogel being produced to be dryable in a customary belt dryer, or other drying apparatuses customary on an industrial scale, without loss of Centrifuge Retention Capacity (CRC).

The neutralized hydrogel is then dried with a belt, fluidized bed, shaft or drum dryer until the residual moisture content is below 15%, preferably below 10% by weight and especially below 5% by weight, as determined by the water or moisture test method described below.

The dried hydrogel is subsequently ground and sieved, useful grinding apparatus typically including roll mills, pin mills or swing mills, the sieves employed having mesh sizes necessary to produce the water-absorbing polymeric particles to give the base polymer.

Preferably less than 2% by weight, more preferably less than 1.5% by weight and most preferably less than 1% by weight of the polymeric particles have a particle size of above 850 μm.

Preferably not less than 90% by weight, more preferably not less than 95% by weight, even more preferably not less than 98% by weight and most preferably not less than 99% by weight of the polymeric particles have a particle size in the range from 150 to 850 μm.

In a more preferred embodiment preferably not less than 90% by weight, more preferably not less than 95% by weight, even more preferably not less than 98% by weight and most preferably not less than 99% by weight of the polymeric particles have a particle size in the range from 150 to 700 μm.

In another more preferred embodiment preferably not less than 90% by weight, more preferably not less than 95% by weight, even more preferably not less than 98% by weight and most preferably not less than 99% by weight of the polymeric particles have a particle size in the range from 150 to 500 μm.

In a most preferred embodiment preferably not less than 90% by weight, more preferably not less than 95% by weight, even more preferably not less than 98% by weight and most preferably not less than 99% by weight of the polymeric particles have a particle size in the range from 150 to 600 μm.

Usually less than 15% by weight, preferably less than 14% by weight, more preferably less than 13% by weight, even more preferably less than 12% by weight and most preferably less than 11% by weight of the polymeric particles have a particle size of less than 300 μm.

The dried base polymer used in the process of the present invention typically has a residual moisture content in the range from 0% to 13% by weight and preferably in the range from 2% to 9% by weight after drying and before application of the post-crosslinking solution.

### Surface Modifying Agent—Postcrosslinking

The base polymers are subsequently surface modified by postcrosslinking. Useful postcrosslinkers vi) are compounds comprising two or more groups capable of forming covalent bonds with the carboxylate groups of the polymers. Useful compounds are for example alkoxysilyl compounds, polyaziridines, polyamines, polyamidoamines, di- or polyglycidyl compounds as described in EP-A 083 022, EP-A 543 303 and EP-A 937 736, polyhydric alcohols as described in DE-C 33 14 019, DE-C 35 23 617 and EP-A 450 922, or R-hydroxyalkylamides as described in DE-A 102 04 938 and U.S. Pat. No. 6,239,230. It is also possible to use compounds of mixed functionality, such as glycidol, 3-ethyl-3-oxetanemethanol (trimethylolpropaneoxetane), as described in EP-A 1 199 327, aminoethanol, diethanolamine, triethanolamine or compounds which develop a further functionality after the first reaction, such as ethylene oxide, propylene oxide, isobutylene oxide, aziridine, azetidine or oxetane.

Useful postcrosslinkers vi) further include cyclic carbonates as disclosed by DE-A 40 20 780, 2-oxazolidone and its derivatives, such as N-(2-hydroxyethyl)-2-oxazolidone as disclosed by DE-A 198 07 502, bis- and poly-2-oxazolidones as disclosed by DE-A 198 07 992, 2-oxotetrahydro-1,3-oxazine and its derivatives as disclosed by DE-A 198 54 573, N-acyl-2-oxazolidones as disclosed by DE-A 198 54 574, cyclic ureas as disclosed by DE-A 102 04 937, bicyclic amide acetals as disclosed by DE 103 34 584, oxetanes and cyclic ureas as disclosed by EP-A 1 199 327 and morpholine-2,3-dione and its derivatives as disclosed by WO 03/031482.

Postcrosslinking is typically carried out by spraying a solution of the postcrosslinker onto the hydrogel or the dry base-polymeric particles. Spraying is followed by thermal drying, and the postcrosslinking reaction can take place not only before but also during drying.

Preferred postcrosslinkers vi) are amide acetals or carbamic esters of the general formule I

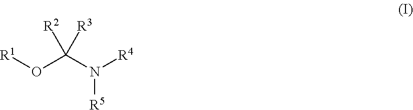

where
R, is C₁-C₁₂-alkyl, C₂-C₁₂-hydroxyalkyl, C₂-C₁₂-alkenyl or C₆-C₁₂-aryl,
R² is X or OR⁶
R³ is hydrogen, C₁-C₁₂-alkyl, C₂-C₁₂-hydroxyalkyl, C₂-C₁₂-alkenyl or C₆-C₁₂-aryl, or X,
R⁴ is C₁-C₁₂-alkyl, C₂-C₁₂-hydroxyalkyl, C₂-C₁₂-alkenyl or C₆-C₁₂-aryl
R⁵ is hydrogen, C₁-C₁₂-alkyl, C₂-C₁₂-hydroxyalkyl, C₂-C₁₂-alkenyl, C₁-C₁₂-acyl or C₆-C₁₂-aryl,
R⁶ is C₁-C₁₂-alkyl, C₂-C₁₂-hydroxyalkyl, C₂-C₁₂-alkenyl or C₆-C₁₂-aryl and
X is a carbonyl oxygen common to R² and R³,
   wherein R¹ and R⁴ and/or R⁵ and R⁶ can be a bridged C₂-C₆-alkanediyl and wherein the abovementioned radicals R¹ to R⁶ can still have in total one to two free valences and can be attached through these free valences to at least one suitable basic structure,
   or polyhydric alcohols, in which case the molecular weight of the polyhydric alcohol is preferably less than 100 g/mol, preferably less than 90 g/mol, more preferably less than 80 g/mol and most preferably less than 70 g/mol per hydroxyl group and the polyhydric alcohol has no vicinal, geminal, secondary or tertiary hydroxyl groups, and polyhydric alcohols are either diols of the general formula IIa

HO—R⁶—OH (IIa)

where R⁶ is either an unbranched dialkyl radical of the formula —(CH2)n-, where n is an integer from 2 to 20 and preferably from 2 to 12, although 2 and 4 are less preferable, and both the hydroxyl groups are terminal, or an unbranched, branched or cyclic dialkyl radical
or polyols of the general formula IIb

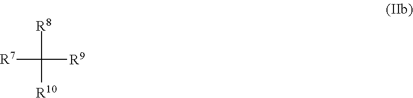

where R⁷, R⁸, R⁹ and R¹⁰ are independently hydrogen, hydroxyl, hydroxymethyl, hydroxyethyloxymethyl, 1-hydroxyprop-2-yloxymethyl, 2-hydroxypropyloxymethyl, methyl, ethyl, n-propyl, isopropyl, n-butyl, n-pentyl, n-hexyl, 1,2-dihydroxyethyl, 2-hydroxyethyl, 3-hydroxypropyl or 4-hydroxybutyl and in total 2, 3 or 4 and preferably 2 or 3 hydroxyl groups are present, and not more than one of R⁷, R⁸, R⁹ and R¹⁰ is hydroxyl,
or cyclic carbonates of the general formula III

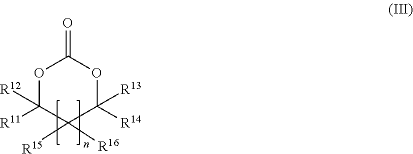

where R¹¹, R¹², R¹³, R¹⁴, R¹⁵ and R¹⁶ are independently hydrogen, methyl, ethyl, n-propyl, isopropyl, n-butyl, sec-butyl or isobutyl, and n is either 0 or 1, or bisoxazolines of the general formula IV

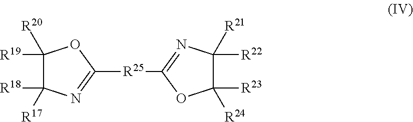

where R¹⁷, R¹⁸, R¹⁹, R²⁰, R²¹, R²², R²³ and R²⁴ are independently hydrogen, methyl, ethyl, n-propyl, isopropyl, n-butyl, sec-butyl or isobutyl and R²⁵ is a single bond, a linear, branched or cyclic C₁-C₁₂-dialkyl radical or polyalkoxydiyl radical which is constructed of one to ten ethylene oxide and/or propylene oxide units, and is possessed by polyglycoldicarboxylic acids for example.

The preferred postcrosslinkers vi) are extremely selective. Byproducts and secondary reactions which lead to volatile and hence malodorous compounds are minimized. The water-absorbing polymers produced with preferred postcrosslinkers vi) are therefore odor neutral even in the moistened state.

Epoxy compounds, by contrast, may at high temperatures in the presence of suitable catalysts undergo various rearrangement reactions which lead to aldehydes or ketones for example. These can then undergo further secondary reactions which eventually lead to the formation of malodorous impurities which are undesirable in hygiene articles due to their odor. Therefore, epoxy compounds are less suitable for post-crosslinking above a temperature of about 140 to 150° C. Amino- or imino-comprising postcrosslinkers vi) will at similar temperatures undergo even more involved rearrangement reactions which tend to give rise to malodorous trace impurities and brownish product discolorations.

Polyhydric alcohols employed as postcrosslinkers vi) require high post-crosslinking temperatures due to their low reactivity. Alcohols comprising vincinal, geminal, secondary and tertiary hydroxyl groups, when employed as postcrosslinkers, give rise to byproducts which are undesirable in the hygiene sector because they lead to unpleasant odors and/or discolorations of the corresponding hygiene article during manufacture or use.

Preferred postcrosslinkers vi) of the general formula I are 2-oxazolidones, such as 2-oxazolidone and N-(2-hydroxyethyl)-2-oxazolidone, N-methyl-2-oxazolidone, N-acyl-2-oxazolidones, such as N-acetyl-2-oxazolidone, 2-oxotetrahydro-1,3-oxazine, bicyclic amide acetals, such as 5-methyl-1-aza-4,6-dioxabicyclo[3.3.0]octane, 1-aza-4,6-dioxabicyclo[3.3.0]octane and 5-isopropyl-1-aza-4,6-dioxabicyclo [3.3.0]octane, bis-2-oxazolidones and poly-2-oxazolidones.

Particularly preferred postcrosslinkers vi) of the general formula I are 2-oxazolidone, N-methyl-2-oxazolidone, N-(2-hydroxyethyl)-2-oxazolidone and N-hydroxypropyl-2-oxazolidone.

Preferred postcrosslinkers vi) of the general formula IIa are 1,3-propanediol, 1,5-pentanediol, 1,6-hexanediol and 1,7-heptanediol. Further examples of postcrosslinkers of the formula IIa are 1,3-butanediol, 1,8-octanediol, 1,9-nonanediol and 1,10-decanediol.

The diols IIa are preferably soluble in water in that the diols of the general formula IIa dissolve in water at 23° C. to an extent of not less than 30% by weight, preferably not less than 40% by weight, more preferably not less than 50% by weight and most preferably not less than 60% by weight, examples being 1,3-propanediol and 1,7-heptanediol. Even more preference is given to such postcrosslinkers are liquid at 25° C.

Preferred postcrosslinkers vi) of the general formula IIb are 1,2,3-butanetriol, 1,2,4-butanetriol, glycerol, trimethylolpropane, trimethylolethane, pentaerythritol, ethoxylated glycerol, trimethylolethane or trimethylolpropane each having 1 to 3 ethylene oxide units per molecule, propoxylated glycerol, trimethylolethane or trimethylolpropane each having 1 to 3 propylene oxide units per molecule. Preference is further given to 2-tuply ethoxylated or propoxylated neopentylglycol. Particular preference is given to 2-tuply and 3-tuply ethoxylated glycerol and trimethylolpropane.

Preferred polyhydric alcohols IIa and IIb have a 23° C. viscosity of less than 3000 mPas, preferably less than 1500 mPas, more preferably less than 1000 mPas, even more preferably less than 500 mPas and most preferably less than 300 mPas.

Particularly preferred postcrosslinkers vi) of the general formula III are ethylene carbonate and propylene carbonate.

A particularly preferred postcrosslinker vi) of the general formula IV is 2,2′-bis(2-oxazoline).

The at least one postcrosslinker vi) is used in an amount of less than 1% by weight, preferably less than 0.5% by weight, and is typically used in an amount of not more than 0.30% by weight, preferably not more than 0.15% by weight and more preferably in the range from 0.001% to 0.095% by weight, all percentages being based on the base polymer, as an aqueous solution.

It is possible to use a single postcrosslinker vi) from the above selection or any desired mixtures of various postcrosslinkers.

The aqueous postcrosslinking solution, as well as the at least one postcrosslinker yl), can typically further comprise a cosolvent.

Cosolvents which are technically highly useful are C₁-C₆-alcohols, such as methanol, ethanol, n-propanol, isopropanol, n-butanol, sec-butanol, tert-butanol or 2-methyl-1-propanol, C₂-C₅-diols, such as ethylene glycol, 1,2-propylene glycol or 1,4-butanediol, ketones, such as acetone, or carboxylic esters, such as ethyl acetate. The disadvantage with many of these cosolvents is that they have characteristic intrinsic odors. Particularly suitable cosolvents are isopropanole and 1,2-propandiole.

The cosolvent itself is ideally not a postcrosslinker under the reaction conditions. However, in a borderline case and depending on the residence time and the temperature, the cosolvent may to some extent contribute to crosslinking. This will be the case in particular when the postcrosslinker vi) is relatively unreactive and therefore is itself able to form its cosolvent, as with the use for example of cyclic carbonates of the general formula III, diols of the general formula IIa or polyols of the general formula IIb. Such postcrosslinkers vi) can also be used as cosolvent when admixed with more reactive postcrosslinkers vi), since the actual postcrosslinking reaction can then be carried out at lower temperatures and/or shorter residence times than in the absence of the more reactive crosslinker v). Since the cosolvent is used in relatively large amounts and will also remain to some extent in the product, it must be toxicologically safe.

The diols of the general formula IIa, the polyols of the general formula IIb and also the cyclic carbonates of the general formula III are also useful as cosolvents in the process of the present invention. They perform this function in the presence of a reactive postcrosslinker vi) of the general formula I and/or IV and/or of a di- or triglycidyl crosslinker. However, preferred cosolvents in the process of the present invention are in particular the diols of the general formula IIa, especially when the hydroxyl groups are sterically hindered by neighboring groups from participating in a reaction. Such diols are in principle also useful as postcrosslinkers yl), but for this require distinctly higher reaction temperatures or optionally higher amounts than sterically unhindered diols. Useful sterically hindered and hence unreactive diols also include diols having tertiary hydroxyl groups.

Examples of such sterically hindered diols of the general formula IIa which are therefore particularly preferred for use as a cosolvent are 2,2-dimethyl-1,3-propanediol (neopentylglycol), 2-ethyl-1,3-hexanediol, 2-methyl-1,3-propanediol and 2,4-dimethylpentane-2,4-diol.

Particularly preferred cosolvents in the process of the present invention further include the polyols of the general formula IIb. Among these, the 2- to 3-tuply alkoxylated polyols are preferred in particular. But particularly useful cosolvents further include 3- to 15-tuply and most particularly 5- to 10-tuply ethoxylated polyols based on glycerol, trimethylolpropane, trimethylolethane or pentaerythritol. Seven-tuply ethoxylated trimethylolpropane is particularly useful.

Useful cosolvents further include di(trimethylolpropane) and also 5-ethyl-1,3-dioxane-5-methanol.

Particularly preferred combinations of less reactive postcrosslinker vi) as cosolvent and reactive postcrosslinker vi) are combinations of preferred polyhydric alcohols, diols of the general formula IIa and polyols of the general formula IIb, with amide acetals or carbamic esters of the general formula I.

Very particularly preferred combinations are 2-oxazolidone/1,3-propanediol and N-(2-hydroxyethyl)-2-oxazolidone/1,3-propanediol.

Very particularly preferred combinations further include 2-oxazolidone or N-(2-hydroxyethyl)-2-oxazolidone as a reactive crosslinker combined with 1,5-pentanediol or 1,6-hexanediol or 2-methyl-1,3-propanediol or 2,2-dimethyl-1,3-propanediol, dissolved in water and/or isopropanol as non-reactive solvent.

In one preferred embodiment the boiling point of the at least one postcrosslinker vi) is preferably no higher than 160° C., more preferably no higher than 140° C. and most preferably no higher than 120° C. or preferably no lower than 200° C., more preferably no lower than 220° C. and most preferably no lower than 250° C.

In another preferred embodiment the boiling point of cosolvent is preferably no higher than 160° C., more preferably no higher than 140° C. and most preferably no higher than 120° C. or preferably no lower than 200° C., more preferably no lower than 220° C. and most preferably no lower than 250° C.

In yet another preferred embodiment particularly useful cosolvents in the process of the present invention therefore also include those which form a low boiling azeotrope with water or with a second cosolvent. The boiling point of this azeotrope is preferably no higher than 160° C., more preferably no higher than 140° C. and most preferably no higher than 120° C. Water vapor volatile cosolvents are likewise very useful, since they can be wholly or partly removed with the water evaporating in the course of drying.

The concentration of cosolvent in the aqueous postcrosslinker solution is frequently in the range from 15% to 50% by weight, preferably in the range from 15% to 40% by weight and more preferably in the range from 20% to 35% by weight, based on the postcrosslinker solution. In the case of cosolvents having a limited miscibility with water, it will be advantageous to adjust the aqueous postcrosslinker solution such that there is only one phase, optionally by lowering the concentration of cosolvent.

A preferred embodiment does not utilize any cosolvent. The at least one postcrosslinker vi) is then only employed as a solution in water, with or without an added deagglomerating aid.

The concentration of the at least one postcrosslinker vi) in the aqueous postcrosslinker solution is for example in the range from 1% to 20% by weight, preferably in the range from 1.5% to 10% by weight and more preferably in the range from 2% to 5% by weight, based on the postcrosslinker solution.

The total amount of postcrosslinker solution based on base polymer is usually in the range from 0.3% to 15% by weight and preferably in the range from 2% to 6% by weight.

There are several methods to produce a postcrosslinked water-absorbing polymer having a Centrifuge Retention Capacity (CRC) of at least 25 g/g, an AUL of ≧15 g/g, a Saline Flow Conductivity (SFC) of at least 80×10⁻⁷ cm³s/g known to the person skilled in the art.

Spray nozzles useful in the process of the present invention are not subject to any restriction. Two-phase or single phase nozzles may be used. Such nozzles can be pressure fed with the liquid to be spray dispensed. The atomizing of the liquid to be spray dispensed can in this case be effected by decompressing the liquid in the nozzle bore after the liquid has reached a certain minimum velocity. Also useful are single-phase nozzles, for example slot nozzles or swirl or whirl chambers (full cone nozzles) (available for example from Düsen-Schlick GmbH, Germany or from Spraying Systems Deutschland GmbH, Germany). Such nozzles are also described in EP-A-0 534 228 and EP-A-1 191 051.

After spraying, the polymeric powder is thermally dried, and the postcrosslinking reaction can take place before, during or after drying.

The spraying with the solution of postcrosslinker is preferably carried out in mixers having moving mixing implements, such as screw mixers, paddle mixers, disk mixers, plowshare mixers and shovel mixers. Particular preference is given to vertical mixers and very particular preference to plowshare mixers and shovel mixers. Useful mixers include for example LöDige® mixers, Bepex® mixers, Nauta® mixers, Processall® mixers and Schugi® mixers.

Contact dryers are preferable, shovel dryers more preferable and disk dryers most preferable as apparatus in which thermal drying is carried out. Suitable dryers include for example Bepex® dryers and Nara® dryers. Fluidized bed dryers can be used as well—batch and continuous fluidized or spouted bed processes are possible.

Drying can take place in the mixer itself, for example by heating the jacket or introducing a stream of warm air. It is similarly possible to use a downstream dryer, for example a tray dryer, a rotary tube oven or a heatable screw. But it is also possible for example to utilize an azeotropic distillation as a drying process.

It is particularly preferable to apply the solution of postcrosslinker in a high speed mixer, for example of the Schugi-Flexomix® or Turbolizer® type, to the base polymer and the latter can then be thermally postcrosslinked in a reaction dryer, for example of the Nara-Paddle-Dryer® type or a disk dryer. The base polymer used can still have a temperature in the range from 10 to 120° C. from preceding operations, and the post-crosslinking solution can have a temperature in the range from 0 to 150° C. More particularly, the postcrosslinking solution can be heated to lower the viscosity. The preferred postcrosslinking and drying temperature range is from 30 to 220° C., especially from 150 to 210° C. and most preferably from 160 to 190° C. The preferred residence time at this temperature in the reaction mixer or dryer is below 100 minutes, more preferably below 70 minutes and most preferably below 40 minutes.

The postcrosslinking dryer is flushed with air to remove vapors during the drying and postcrosslinking reaction. To augment the drying process, the dryer and the attached assemblies are ideally fully heated.

Cosolvents removed with the vapors may of course be condensed again outside the reaction dryer and optionally recycled.

After the reactive drying step has been concluded, the dried water-absorbing polymeric particles are cooled. To this end, the warm and dry polymer is preferably continuously transferred into a downstream cooler. This can be for example a disk cooler, a Nara paddle cooler or a screw cooler. Cooling is via the walls and optionally the stirring elements of the cooler, through which a suitable cooling medium such as for example warm or cold water flows. Water or aqueous solutions of additives may preferably be sprayed on in the cooler; this increases the efficiency of cooling (partial evaporation of water) and the residual moisture content in the finished product can be adjusted to a value in the range from 0% to 6% by weight, preferably in the range from 0.01% to 4% by weight and more preferably in the range from 0.1% to 3% by weight. The increased residual moisture content reduces the dust content of the product.

Optionally, however, it is possible to use the cooler for cooling only and to carry out the addition of water and additives in a downstream separate mixer. Cooling stops the reaction by lowering the temperature to below the reaction temperature and the temperature needs altogether only to be lowered to such an extent that the product is easily packable into plastic bags or into silo trucks.

Optionally, however, this moisture content can also be raised up to 75% by weight, for example by applying water in an upstream spraying mixer. Such an increase in the moisture content leads to a slight preswelling of the base polymer and improves the distribution of the crosslinker on the surface and also the penetration through the particles.

Post-crosslinked water-absorbing polymeric particles having a Centrifuge Retention Capacity (CRC) of at least 25 g/g, an AUL of at least ≧15 g/g and a Saline Flow Conductivity (SFC) of at least ≧80 are known to a person skilled in the art.

Post-crosslinked water absorbing particles with the above performance properties may be obtained by the procedures described in WO 2006/042704, WO 2005/080479, WO 2002/060983, WO 2004/024816, WO 2005/097881, WO 2008/092843, WO 2008/092842, PCT/EP 2008/059495 and PCT/EP 2008/059496 which are expressly incorporated in here by reference.

According to one preferred embodiment they are obtained by surface modifying of the base water-absorbing polymer with a postcrosslinker and at least one water soluble polyvalent metal salts preferably an aluminium salt. They are described in WO 2005/097881 which is expressly incorporated in here by reference.

According to another preferred embodiment they are obtained by surface modifying of the base water-absorbing polymer with a postcrosslinker and at least one water-insoluble metal phosphate preferably a calcium phosphate. They are described in WO 2002/060983 which are expressly incorporated in here by reference.

According to another preferred embodiment they are obtained by surface modifying of the base water-absorbing polymer with a postcrosslinker and at least one film forming polymer The dispersions are not limited to any chemistry, but preferred are aqueous polymer dispersions based on Polyurethanes or Polyacrylates or mixtures of both as e.g. commercial available Polyurethane Astacin PUMN TF (BASF SE) or Polyacrylate Corial Binder IF (BASF SE).

The water content of the post-crosslinked water-absorbing polymeric particles (prior to vacuum and/or plasma treatment) according to the present invention is preferably less than 6% by weight, more preferably less than 4% by weight and most preferably less than 3% by weight.

The Centrifuge Retention Capacity (CRC) of the post-crosslinked water absorbing polymeric particles prior to vacuum and/or plasma treatment is usually not less than 25 g/g, preferably not less than 26 g/g, more preferably not less than 27 g/g, even more preferably not less than 30 g/g and usually not above 50 g/g.

The absorbency under a load of 4.83 kPa (AU L0.7 psi) of the post-crosslinked water absorbing polymeric particles prior to vacuum and/or plasma treatment is usually not less than 15 g/g, preferably not less than 19 g/g, more preferably not less than 21 g/g, even more preferably not less than 22 g/g and most preferably not less than 23 g/g and usually not above 30 g/g.

The Saline Flow Conductivity (SFC) of the polymeric particles prior to vacuum and/or plasma treatment is usually not less than 50×10⁻⁷ cm³s/g, preferably not less than 80×10⁻⁷ cm³s/g, more preferably not less than 110×10⁻⁷ cm³s/g, even more preferably not less than 150×10⁻⁷ cm³s/g and most preferably not less than 200×10⁻⁷ cm³s/g and usually not above 1000×10⁻⁷ cm³s/g.

In one particular preferred embodiment the water-absorbing polymer particles of the present invention are produced by
a) polymerization of a monomer solution comprising
   i) at least one ethylenically unsaturated acid functional monomer,
   ii) at least one ethylenically unsaturated crosslinker,
   iii) optionally one or more ethylenically and/or allylically unsaturated monomers copolymerizable with i),
   iv) optionally one or more water-soluble polymers grafted wholly or partly with the monomers i), ii) and optionally iii),
   v) optionally in the presence of a non radical crosslinking agent, having in its single molecule two or more functional groups each of which allows formation of an ester or an amide bond by reaction with carboxyl groups.
b) drying, grinding, sifting and subsequent post-crosslinking of the hydrogels obtained from the polymerization step a),
c) coating before, during or after post-crosslinking with at least one water soluble polyvalent metal salt, preferably selected from aluminum lactate, zirconium lactate, aluminum sulfate, zirconium sulfate,
d) vacuum treatment of the post-crosslinked water absorbing polymeric particles, and
e) optionally, plasma treatment prior, during or after execution of step d).

In another particular preferred embodiment the water-absorbing polymers particles of the present invention are produced by
a) polymerization of a monomer solution comprising
   i) at least one ethylenically unsaturated acid functional monomer,
   ii) at least one ethylenically unsaturated crosslinker,
   iii) optionally one or more ethylenically and/or allylically unsaturated monomers copolymerizable with i),
   iv) optionally one or more water-soluble polymers grafted wholly or partly with the monomers i), ii) and optionally iii),
   v) optionally in the presence of a non radical crosslinking agent, having in its single molecule two or more functional groups each of which allows formation of an ester or an amide bond by reaction with carboxyl groups.
b) drying, grinding, sifting and subsequent post-crosslinking of the hydrogels obtained from the polymerization step a),
c) coating before, during or after post-crosslinking with at least one film forming polymer preferably selected from polyurethanes and polyacrylates, and are optionally heat treated after coating at a temperature between 40-190° C. for a time period between 0-90 minutes,
d) vacuum treatment of the post-crosslinked water absorbing polymeric particles, and
e) optionally, plasma treatment prior, during or after execution of step d).

In another particular preferred embodiment the water-absorbing polymers particles of the present invention are produced by
a) polymerization of a monomer solution comprising
   i) at least one ethylenically unsaturated acid functional monomer,
   ii) at least one ethylenically unsaturated crosslinker,
   iii) optionally one or more ethylenically and/or allylically unsaturated monomers copolymerizable with i),
   vi) optionally one or more water-soluble polymers grafted wholly or partly with the monomers i), ii) and optionally iii),
   v) optionally in the presence of a non radical crosslinking agent, having in its single molecule two or more functional groups each of which allows formation of an ester or an amide bond by reaction with carboxyl groups.
b) drying, grinding, sifting and subsequent post-crosslinking of the hydrogels obtained from the polymerization step a),
c) coating before, during or after post-crosslinking with at least one inorganic permeability enhancing agent preferably selected from water-insoluble metal phosphates, inorganic particles for example silica, clay, or mica, which can be applied as powders or as aqueous dispersions,
d) vacuum treatment of the post-crosslinked water absorbing polymeric particles, and
e) optionally, plasma treatment prior, during or after execution of step d).

In another particular preferred embodiment the water-absorbing polymers particles of the present invention are produced by
a) polymerization of a monomer solution comprising
   i) at least one ethylenically unsaturated acid functional monomer,
   ii) at least one ethylenically unsaturated crosslinker,
   iii) optionally one or more ethylenically and/or allylically unsaturated monomers copolymerizable with i),
   vi) optionally one or more water-soluble polymers grafted wholly or partly with the monomers i), ii) and optionally iii),
   v) optionally in the presence of a non radical crosslinking agent, having in its single molecule two or more functional groups each of which allows formation of an ester or an amide bond by reaction with carboxyl groups.
b) drying, grinding, sifting and subsequent post-crosslinking of the hydrogels obtained from the polymerization step a),
c) coating before, during or after post-crosslinking with at least one inorganic permeability enhancing agent preferably selected from water-insoluble metal phosphates, inorganic particles for example silica, clay, or mica, which can be applied as powders or as aqueous dispersions,
   and at least one water soluble polyvalent metal salt, preferably selected from aluminum lactate, zirconium lactate, aluminum sulfate, zirconium sulfate, and are coated before, during or after post-crosslinking with at least one film forming polymer preferably selected from polyurethanes and polyacrylates, and are optionally heat treated after coating at a temperature between 40-190° C. for a time period between 0-90 minutes,
d) vacuum treatment of the post-crosslinked water absorbing polymeric particles, and
e) optionally, plasma treatment prior, during or after execution of step d).

In a preferred embodiment the method of producing water-absorbing particles comprises the step of treating the water-absorbing particles with water and/or a water-miscible organic solvents prior to vacuum- and/or prior to plasma treatment.

Preferably the water-absorbing particles are treated with 0.1 to 5% by weight of the water-absorbing particles with water and/or a water miscible-organic solvent. Suitable water-miscible organic solvent are for example aliphatic C₁-C₄-alcohols, such as methanol, i-propanol and t-butanol, polyhydric alcohols, such as ethylene glycol, 1,2-propanediol and glycerol, ethers, such as methyltriglycol and polyethylene glycols having average molecular weight M_{w} of 200-10 000 and also ketones such as acetone and 2-butanone.

### The Vacuum-Treatment

The post-crosslinked water-absorbing polymeric particles according to the present invention are vacuum treated, after production (=after cooling the product to below 100° C. when leaving the post-cross-linking step) and prior to packaging.

Such vacuum-treatment are obtained by lowering the atmospheric pressure in a batch or continuous process step from ambient atmospheric pressure (typically around 1023 mbar but dependent on weather conditions and plant elevation level) to less than 80% ambient atmospheric pressure, preferably less than 60% ambient atmospheric pressure, more preferably less than 40% ambient pressure, even more preferably less than 20% ambient pressure, and most preferably to less than 5% ambient pressure.

In one preferred embodiment the pressure is lowered to ≦400, preferably ≦20 mbar, more preferably ≦10 mbar, most preferably ≦1 mbar but typically not below 0.0001 mbar.

The exposure time to the vacuum conditions is typically about 0.1 seconds to 30 minutes, preferably 0.5 seconds to 15 minutes, more preferably 1 second to 10 minutes, even more preferably 5 seconds to 5 minutes, and most preferably 10 seconds to 3 minutes.

Particulate solids such as superabsorbents are frequently transported by pneumatic conveying in tubes. Typically, this involves the use of pressurized gas. It is also possible, however, to convey particles by suction. For conveying purposes, the vacuum conditions are typically set to gently move the particles to the desired place to avoid attrition problems. The vacuum applied in these conveying methods is generally not sufficient as vacuum treatment according to this invention in terms of pressure and/or exposure time. It is preferred to not combine the vacuum treatment step of this invention with a dedicated conveying step, but in particular where attrition is not a concern (that may depend on the specific superabsorbent or intended use), the vacuum treatment according to this invention may be combined with conveying by suction by adjusting the pressure and exposure time conditions accordingly. Adjusting exposure time conditions may need increasing the volume of the pneumatic conveying system by increasing the length of tubes or using extra vessels as buffer volume.

In a particular preferred embodiment of the present invention the plasma treatment is started after the vacuum conditions are established and both treatments are executed simultaneously within the time scales for the vacuum treatment above.

The temperature during vacuum treatment will be preferably below 190° C., more preferably below 140° C., even more preferably below 100° C., most preferably below 60° C., and particularly preferred between 10 and 40° C.

Without wishing to be bound by theory the vacuum treatment step selectively improves the FSR.

### The Plasma Treatment

In one preferred embodiment the post-crosslinked water-absorbing polymer is plasma treated. Without wishing to be bound by theory the plasma treatment step selectively improves the FHA, and may simultaneously improve the FSR in particularly when executed under vacuum conditions.

The plasma treatment step can take place prior, during or after vacuum treatment. In a particular preferred embodiment it takes place during the vacuum treatment step.

The plasma-treatment can take place under vacuum conditions or at ambient pressure. Both batch processes and continuous processes are known to a person skilled in the art for example to modify polymer surfaces and textiles. It is preferable to use air, moisture, moist air, dry air, nitrogen, argon, water vapor, ammonia, oxygen, carbon dioxide, organic solvent vapors, inorganic vapors or any mixture thereof as residual atmosphere for carrying out the plasma treatment. Particularly preferred are air, oxygen, nitrogen, argon, water vapor, carbon dioxide and any mixture thereof. An air plasma is most preferred.

Plasma treatment can be carried out over a wide range of pressures and temperatures. It is however preferred to treat the water-absorbing polymeric particles at the temperature at which they leave the production process. The temperature will therefore be preferably below 190° C., more preferably below 140° C., even more preferably below 100° C., most preferably below 60° C., and particularly preferred between 10 and 40° C.

In one embodiment the precursor gas used in the generation of the plasma is, by way of example only, a noble, inert or nitrogenous gas.

Suitable types of plasma and remote plasma can be used and reference to the use of plasma can include the use of any or any combination of pulsed and/or continuous wave plasma and include non-equilibrium plasmas such as those generated by radio frequency (RF), microwaves and/or direct current. The plasma can be operated at low pressures, atmospheric or sub-atmospheric pressures to suit particular purposes.

In one embodiment, the post-crosslinked, optionally coated, water-absorbing particles are treated with water and/or water-miscible organic solvents prior to vacuum- and/or prior to plasma treatment. For example, the post-crosslinked and optionally coated water-absorbing particles are treated with 0.1 to 5% by weight (of particles) with water and/or a water miscible-organic solvent. Suitable water-miscible organic solvents are for example aliphatic C1-C4-alcohols, such as methanol, i-propanol and t-butanol, polyhydric alcohols, such as ethylene glycol, 1,2-propanediol and glycerol, ethers, such as methyltriglycol and polyethylene glycols having average molecular weight Mw of 200-10 000 and also ketones such as acetone and 2-butanone.

Said surface-modified post-crosslinked water-absorbing polymeric particles may have, in one embodiment herein, a Centrifuge Retention Capacity (CRC; or CCRC) of at least 20 g/g, or at least 25 g/g and for example up to 50 g/g; they may and/or an Absorbency Under Load (AU L; or CS-AU L) of at least 15 g/g, preferably at least 19 g/g, or for example at least 21 g/g. They may have a Saline Flow Conductivity (SFC) (or for coated particles as described herein: a CS-SFC) of at least 50 or at least 80×10 7 cm³s/g, preferably of at least 100×10⁷ cm³s/g. In one embodiment, they may preferably have a SFC of at least 150×10⁷ cm³s/g, or of at least 200×10⁷ cm³s/g.

In one embodiment, the (optionally coated) post-crosslinked water-absorbing polymeric particles have a first FHA value, and after said vacuum and/or plasma treatment, or in particular after said vacuum treatment step and said (additional or simultaneous) plasma treatment step, said resulting surface-modified (optionally coated) post-crosslinked water-absorbing polymeric particles have a second FHA, and said second FHA is at least 10%, or at least 20%, or at least 30% more than said first FHA.

In one embodiment, the surface-modified (coated) post-crosslinked water-absorbing polymeric particles, submitted to said vacuum treatment step and to optionally, or for example preferably, said plasma treatment step, may have a FHA of at least 8 g/g, or for example at least 10 g/g or at least 12 g/g or at least 15 g/g, or at least 20 g/g, or at least 23 g/g.

### Additional Coating or Surface Modifying Agents

In addition to the treatment with plasma and/or vacuum, the water-absorbing polymeric particles or the post-crosslinked water-absorbing polymeric particles may be coated with coating agent(s); such material is herein referred to as coated post-crosslinked water-absorbent polymeric particles, and surface-treated coated post-crosslinked water-absorbing polymeric particles.

Coating may be done before, during or after post-crosslinking. In one embodiment, the coating takes place after post-crosslinking.

The coating may for example be done with apparatuses described above for the post-crosslinking. It may for example be done in the same step as the post-crosslinking. Such coating with coating agents makes it possible to achieve additional effects, such as a reduced tendency to cake, improved processing properties or a further enhanced Saline Flow Conductivity (SFC).

“Coating” when used herein includes partial coatings, whereby the outer surface of the particles are partially covered with a coating agent, homogeneous coatings, whereby the coating is present in a homogeneous amount per surface area of the particle, complete coatings, whereby substantially the complete surface of the particles is covered (and preferably homogeneously) or whereby said coating agent forms a substantially complete network on said surface of said particles (and preferably homogeneously), and homogeneous complete coatings.

The coating agent may be or comprise a hydrolyzed pre-cursor of polyvinylamine, polyethyleneimines, polyallylamines. The coating agent may be or comprise a metal phosphates, inorganic particles, and water soluble polyvalent metal salts.

In a particular embodiment polyvalent metal salts, most preferably water soluble polyvalent metal salts, like for example but not limited to aluminum sulfate, aluminum nitrate, aluminum chloride, potassium aluminum sulfate, sodium aluminum sulfate, magnesium sulfate, magnesium citrate, magnesium lactate, zirconium sulfate, zirconium lactate, iron lactate, iron citrate, calcium acetate, calcium propionate, calcium citrate, calcium lactate, strontium lactate, zinc lactate, zinc sulfate, zinc citrate, aluminum lactate, aluminum acetate, aluminum formiate, calcium formiate, strontium formiate, strontium acetate may be used as or in said coating agent, e.g. to impart a high passive fluid transport (SFC) by homogeneously coating the surface of the water-absorbing polymeric particles prior to, during or after post-cross-linking. For example, preferred may be a coating agent may be used that is or comprises water soluble polyvalent metal salt, preferably selected from aluminum lactate, zirconium lactate, aluminum sulfate, zirconium sulfate.

The coating agent may be selected from water-insoluble metal phosphates and other inorganic particles, for example silica, clay, or mica, which can be applied as powders or as aqueous dispersions.

In one embodiment, the particles comprise at least a coating of silica, such as commercially available Aerosil®. Silica is known in the art to improve the absorption speed of the water-absorbent polymer particles. The inventors found that when silica is used on water-absorbent polymer particles as known in the art, the permeability may be negatively affected, e.g. SFC may be reduced. Surprisingly, the inventors found that when silica is used as ac coating agent for the surface-modified post-crosslinked water-absorbent polymer particles of the invention, that are treated with a vacuum and optionally said plasma treatment step, the permeability is not reduced by the addition of said silica, whilst the FHA is improved.

Suitable water-insoluble metal phosphates are for example phosphates which can be deemed to be “phosphates” in the technical sense, such as phosphate oxides, phosphate hydroxides, phosphate silicates, phosphate fluorides or the like. As used herein, the term “water-insoluble” denotes a solubility of less than 10 g, preferably of less than 1 g and more preferably less than 0.1 g in 1000 ml of water at 25° C. Suitable water-insoluble metal phosphates and suitable coating processes are described in WO 02/060983 which is expressly incorporated in here by reference. Preferred water-insoluble metal phosphates are pyrophosphates, hydrogenphosphates and phosphates of calcium, of magnesium, of strontium, of barium, of zinc, of iron, of aluminum, of titanium, of zirconium, of hafnium, of tin, of cerium, of scandium, of yttrium or of lanthanum, and also mixtures thereof. Preferred water-insoluble metal phosphates are calcium hydrogenphosphate, calcium phosphate, apatite, Thomas flour, berlinite (AIPO4) and Rhenania phosphate. Particular preference is given to calcium hydrogenphosphate, calcium phosphate and apatite, the term “apatite” denoting fluoroapatite, hydroxyl apatite, chloroapatite, carbonate apatite and carbonate fluoroapatite. It will be appreciated that mixtures of various water-insoluble metal phosphates can be used. The water-insoluble metal phosphates may have an average particle size of usually less than 400 μm, preferably less than 100 μm, more preferably less than 50 μm, even more preferably less than 30 μm and most preferably in the particle size range from 2 to 20 μm.

The fraction of water-insoluble metal phosphate is usually in the range from 0.1% to 1.0% by weight, preferably in the range from 0.2% to 0.8% by weight and more preferably in the range from 0.35% to 0.65% by weight, based on the water-absorbing polymeric particles.

But it is also possible for the water-insoluble metal phosphates to be formed in situ on the surface of the base or post-crosslinked water-absorbing polymeric particles. To this end, solutions of phosphoric acid or of soluble phosphates and solutions of soluble metal salts are separately sprayed on, the water-insoluble metal phosphate forming and depositing on the particle surface.

Suitable inorganic particles may be applied as powders or aqueous dispersions. Examples but not limited to are silica, fumed silica, colloidal dispersed silica, titanium dioxide, aluminum- and magnesium oxide, zinc oxide, clay. Silicas may be hydrophilic or hydrophobic.

Hydrophilic silicas, such as Aerosils, may be used to make the particles more hydrophilic. However, the inventors found that in some embodiments herein, whereby the absorbent structure comprises adhesive, in particular when it comprises thermoplastic adhesive material, such inorganic particles, in particular silicas, may have a negative impact on the absorbent structure's performance.

Some of the coating agents, in particular the polymeric coating agents described herein may render the absorbent structures with the articles more permeable for liquid, increasing thus the SFC of the structure and of the particles, which is highly desirable, but it is believed that they may render the post-crosslinked water-absorbent polymeric particles less hydrophilic. Without wishing to be bound by theory it is understood that a less hydrophilic surface of the water-absorbing polymeric particles typically reduces the FSR and the FHA comes with a much improved SFC. Thus, for such coated particles herein, said surface treatment with vacuum and/or plasma, as described herein, is particular beneficial.

Coating may for example be done before, or (in one embodiment preferably) during or after post-crosslinking, with a coating agent selected from: film-forming polymers and/or elastic polymers and/or elastic film-forming polymers. Such coating agents are preferably applied to that thet form complete coatings, and preferably homogeneous and complete coatings. They may for example be sprayed on. When the coating agent is sprayed in the form of dispersions, they are preferably used as aqueous dispersions. When applied as a dispersion, the coating agents that are elastic and/or film-forming polymers may be annealed.

Suitable film-forming polymers preferably exhibit elastic physical properties. The elastic and elastic film-forming agents/polymers suitable as coating agents herein are disclosed in U.S. Pat. No. 5,731,365 and in EP 0703265, and also in WO 2006/082242 and WO 2006/097389. In one embodiment the elastic and/or film-forming polymer coating agent is selected from polyurethanes, poly(meth)acrylates, which optionally can be cross-linked by e.g. Zn, polyacrylates, and copolymers of styrene-(meth)acrylate, and copolymers of styrene and/or (meth)acrylate comprising acrylonitrile, copolymers of butadiene-styrene and/or acrylonitrile, (co)polymers of (cross-linkable) NVinylpyrrolidone and (co)polymers of vinylacetate and mixtures thereof.

The elastic and or film-forming polymer is preferably applied as aqueous dispersion and optionally coalescing agents and/or anti-oxidants may be added.

If the elastic and/or film-forming polymer is present, it may for example be present in an amount up to 5 wt. %, or up to 1.5 wt. %, or up to 0.5 wt. %, or for example from 0.01 wt. %, based on the post-crosslinked water-absorbing polymer.

The elastic and/or film-forming polymer herein include single polymers and blends of polymers. ‘Film-forming’ means that the respective polymer can readily be made into a film, i.e. layer or coating, e.g. a homogeneous coating on the particle, upon evaporation of the solvent in which it is dissolved or dispersed. The polymer may for example be thermoplastic or crosslinked.

‘Elastic’ when used herein means that the material will exhibit stress induced deformation that is partially or completely reversed upon removal of the stress.

‘Phase-separating’, when used herein, means that a film of the polymeric coating agent (i.e. prior to use in or as the coating agent and application to the particles) has at least two distinct spacial phases which are distinct and separated from one another, due to their thermodynamic incompatibility. The incompatible phases are comprised of aggregates of only one type of repeat unit or segment of the elastic material. This can for example occur when the polymer is a block (or segmented) copolymer, or a blend of two immiscible polymers, e.g. a elastic and/or a film-forming block (or segmented) copolymer, or blend of immiscible polymers. The phenomenon of phase separation is for example described in: Thermoplastic Elastomers: A Comprehensive Review, eds. Legge, N. R., Holden, G., Schroeder, H. E., 1987, Chapter 2.

Typically, the phase separation occurs in a block copolymer, whereby the segment or block of the copolymer that has a Tg below room temperature (i.e. below 25° C.) is said to be the soft segment or soft block and the segment or block of the copolymer that has a Tg above room temperature is said to be the hard segment or hard block.

The Tg's, as referred to herein, may be measured by Differential Scanning calorimetry (DSC) to measure the change in specific heat that a material undergoes upon heating. The DSC measures the energy required to maintain the temperature of a sample to be the same as the temperature of the inert reference material (eg. Indium). A Tg is determined from the midpoint of the endothermic change in the slope of the baseline. The Tg values are reported from the second heating cycle so that any residual solvent in the sample is removed.

In addition, the phase separation can also be visualised by electron microscopy particularly if one phase can be stained preferentially. Also atomic force microscopy has been described as a particularly useful technique to characterize the morphology (phase-separating behavior) of the preferred thermoplastic polyurethanes, described herein after.

The elastic (e.g. film-forming) polymer herein may comprise at least two phases with different glass transition temperatures (Tg); it comprises for example at least a first phase with a Tg1, which is lower than the Tg2 of a second phase, the difference being at least 30° C.

In one embodiment, the elastic polymer has a first (soft) phase with a Tg1 which is less than 25° C., preferably less than 20° C., more preferably less than 0° C., or even less than −20° C., and a second (hard) phase with a Tg2 of at least 50° C. or even at least 55° C., but more preferably more than 60° C. or even more than 70° C., or in certain embodiments, more than 100° C., provided the temperature difference between Tg1 and Tg2 is at least 30° C., preferably at least 50° C. or even at least 60° C., or in certain embodiments at least 90° C.

It should be understood that, the coating agent itself (i.e. before formation into the coating on the particles) has the herein specified properties, but that that typically, the coating material maintains these properties once in the coating, and that the resulting (film of the) coating should thus preferably have the same properties.

Polymers having film-forming and also elastic properties are generally suitable, such as copolyesters, copolyamides, polyolefins, styrenic block copolymers, including styreneisoprene block copolymers, styrene-butadiene block copolymers, and polyurethanes, and blends thereof, optionally blends including at least polyurethanes. Some include polyurethanes and polyurethane blends.

Polyurethanes useful herein may include one or more phase separating block copolymers, having a weight average molecular weight Mw of at least 5 kg/mol, and may be at least 10 kg/mol and higher. In one embodiment such a block copolymer has at least a first polymerized homopolymer segment (block) and a second polymerized homopolymer segment (block), polymerized with one another, whereby the first (soft) segment may have a Tg1 of less than 25° C. or even less than 20° C., or even less than 0° C., and the second (hard) segment has a Tg2 of at least 50° C., or of 55° C. or more, and may be 60° C. or more or even 70° C. or more.

In another embodiment, such a block copolymer has at least a first polymerized polymer segment (block) and a second polymerized polymer segment (block), polymerized with one another, whereby the first (soft) segment may have a Tg1 of less than 25° C. or even less than 20° C., or even less than 0° C., and the second (hard) segment has a Tg2 of at least 50° C., or of 55° C. or more, may be 60° C. or more or even 70° C. or more.

The weight average molecular weight of a first (soft) segment (with a Tg of less than 25° C.) may be at least 500 g/mol, at least 1000 g/mol or even at least 2000 g/mol, and maybe less than 8000 g/mol, and may be less than 5000 g/mol.

However, the total of the first (soft) segments may be 20% to 95% by weight of the total block copolymer, or even from 20% to 85% or may be from 30% to 75% or even from 40% to 70% by weight. Furthermore, when the total weight level of soft segments is more than 70%, it may be that an individual soft segment has a weight average molecular weight of less than 5000 g/mol.

The elastic and/or film-forming polymer is typically such that at least some of the resulting coating on the water-absorbent polymers herein is not water-soluble and, optionally not water-dispersible once a coating has been formed.

In one embodiment, the hydrophobic film-forming polymer has a minimum film-forming temperature above −10° C., preferably above 20° C., more preferably above 50° C., and most preferably above 80° C.

The polymers herein, such as the polyurethanes herein, can be applied to the post-crosslinked or base water absorbing polymeric particles as a solution or as a dispersion. Some may be aqueous dispersions, further described below. The solution can be prepared using any suitable organic solvent for example acetone, isopropanol, tetrahydrofuran, methyl ethyl ketone, dimethyl sulfoxide, dimethylformamide, N-methylpyrrolidone, chloroform, ethanol, methanol or mixtures thereof.

Suitable elastic and e.g. film-forming polymers which are applicable from solution are for example Vector® 4211 (Dexco Polymers, Texas, USA), Vector 4111, Septon 2063 (Septon Company of America, A Kuraray Group Company), Septon 2007, Estane® 58245 (Noveon, Cleveland, USA), Estane 4988, Estane 4986, Estane® X-1007, Estane T5410, Irogran PS370-201 (Huntsman Polyurethanes), Irogran VP 654/5, Pellethane 2103-70A (Dow Chemical Company), Elastollan® LP 9109 (Elastogran). Some aqueous polyurethane dispersions are Hauthane HD-4638 (ex Hauthaway), Hydrolar® HC 269 (COIMoIm, Italy), Impraperm® 48180 (Bayer Material Science AG, Germany), Lurapret® DPS (BASF Aktiengesellschaft, Germany), Astacin® Finish LD 1603 (BASF Aktiengesellschaft, Germany), Permax® 120, Permax 200, and Permax 220 (Noveon, Brecksville, Ohio), Syntegra YM2000 and Syntegra YM2100 (Dow, Midland, Mich.), Witcobond® G-213, Witcobond G-506, Witcobond G-507, Witcobond 736 (Uniroyal Chemical, Middlebury, Conn.), Astacin Finish PUMN TF, Astacin TOP 140, Astacin Finish SUSI (all BASF) and Impranil® DLF (anionic aliphatic polyesterpolyurethane dispersion from Bayer Material Science).

The coating polymer, e.g. polyurethane, may be hydrophilic and in particular surface hydrophilic. This hydrophilicity may be achieved or enhanced via addition of fillers, surfactants, deagglomeration and coalescing agents. In another embodiment, the hydrophilic properties are (in addition) achieved as a result of the polyurethane including hydrophilic polymer blocks, for example polyether groups having a fraction of groups derived from ethylene glycol (CH2CH2O) or from 1,4 butanediol (CH2CH2CH2CH2O) or from 1,3-propanediol (CH2CH2CH2O) or from 1,2-propanediol (CH(CH3)-CH2O—), or mixtures thereof.

It is further possible to obtain hydrophilic properties for the polyurethanes through an elevated fraction of ionic groups, and may be carboxylate, sulfonate, phosphonate or ammonium groups. The ammonium groups may be protonated or alkylated tertiary or quarternary groups. Carboxylates, sulfonates, and phosphates may be present as alkali-metal or ammonium salts. Suitable ionic groups and their respective precursors are for example described in “Ullmanns Encyclopädie der technischen Chemie”, 4th Edition, Volume 19, p. 311-313 and are furthermore described in DE-A 1 495 745 and WO 03/050156.

It may be preferable to apply the coating in a fluidized bed reactor. The base or post-crosslinked water absorbing particles are introduced as generally customary, depending on the type of the reactor, and are generally coated by spraying with the elastic and/or film-forming polymer as a solid material or may be as a polymeric solution or dispersion. Aqueous dispersions of the elastic and or film-forming polymer may be used for this.

The concentration of elastic and/or film-forming polymer in the solution or dispersion may be in the range from 1% to 60% by weight, may be in the range from 5% to 40% by weight and may be in the range from 10% to 30% by weight.

The resulting coated particles may be annealed. This optional annealing step c) typically involves a step resulting in a further strengthened or more continuous or more completely connected coating and it substantially eliminates defects, e.g. annealing the coating agent (e.g. annealing and thereby connecting the coating agent particles in a dispersion, to form a coating).

Typically, the annealing step) involves a heat treatment of the particles with a coating of said coating agent; it may be done by for example radiation heating, oven heating, convection heating, azeotropic heating, and it may for example take place in conventional equipment used for drying, such as fluidized bed driers.

Preferably, the annealing step involves heating the coated (post-crosslinked) water-absorbing polymers at a temperature which is above the highest Tg of the coating agent preferably to a temperature which is at least 20° C. above said highest Tg. For example, the highest Tg is typically at least 50° C. and the annealing temperature is at least 70° C., or even at least 100° C. or even at least 140° C., and up to 200° C. or even up to 250° C.

If the material has a melting temperature Tm, then the annealing step is at least 20° C. below the Tm and if possible and preferably at least 20° C. or even at least 50° C. above the highest Tg.

The annealing step may be done for, for example, at least 5 minutes, or even for at least 10 minutes or even for at least 15 minutes, or even at least 30 minutes or even at least 1 hour or even at least 2 hours.

This heat-treatment may be done once, or it may be repeated, for example the heat treatment may be repeated with different temperatures, for example first at a lower temperature, for example from 70° C. or 80° C., to 100° C., as described above, for example for at least 30 minutes or even 1 hour, up to 12 hours, and subsequently at a higher temperature, for example from 120° C. to 140° C., for at least 10 minutes.

During the annealing step, the coated water-absorbent polymers may also be dried at the same time.

The coated post-crosslinked water-absorbing polymeric particles or surface-modified coated post-crosslinked water-absorbing polymeric particles herein may have CCRC values that are as the CRC values cited above for the post-crosslinked or surface-modified post-crosslinked water-absorbent polymeric particle, respectively, in particular when the coating agent is one of the polymeric materials above.

The coated post-crosslinked water-absorbing polymeric particles or surface-modified coated post-crosslinked water-absorbing polymeric particles herein may have CS-SFC values that are as the FC values cited above for the post-crosslinked or surface-modified post-crosslinked water-absorbent polymeric particle, respectively, in particular when the coating agent is one of the (elastomeric) polymeric materials above.

### The Absorbent Structure

The water-absorbing polymeric particles of the present invention are very white, which is necessary especially in ultrathin diapers having a high fraction of water-absorbing polymeric particles. Even minimal color variations are visible through the thin topsheet of an ultrathin diaper which is not accepted by customers.

The present invention further provides hygiene articles comprising water-absorbing polymeric particles according to the present invention, preferably ultrathin diapers comprising an absorbent layer consisting of 50% to 100% by weight, preferably 60% to 100% by weight, more preferably 70% to 100% by weight, even more preferably 80% to 100% by weight and most preferably 90% to 100% by weight of water-absorbing polymeric particles according to the present invention, in respect to the absorbent layer taken alone of course.

Such structures preferably comprise discrete patterns of granular water-absorbing polymeric particles deposited onto a non-woven and attached to this non-woven via a plurality of thermoplastic resin bonds. These thermoplastic resin bonds are preferably fiberized to coat the deposits of granular water-absorbing polymeric particles like a spider-web, giving it the ability to freely absorb aqueous liquid while at the same time providing it with dry- and wet integrity. Preferably these thermoplastic bonds also connect the lower non-woven substrate with an upper non-woven substrate to make a closed composite absorbent structure. Most preferably the thermoplastic resin is a hot-melt glue, most preferably a hot-melt glue of the SIS- or SBS-type.

To determine the quality of postcrosslinking, the dried water-absorbing polymeric particles are tested using the test methods described hereinbelow.

The water-absorbing polymeric particles of the present invention are also very advantageous for producing laminates and composite structures as described for example in US-A 2003/0181115 and US-A 2004/0019342. As well as the hotmelt adhesives described in the two references for producing such novel absorbent structures, and especially the hotmelt adhesive fibers which are described in US-A 2003/0181115 and to which the water-absorbing polymeric particles are bound, the water-absorbing polymeric particles of the present invention are also useful for producing completely analogous structures by utilizing UV crosslinkable hotmelt adhesives which are marketed for example as AC-Resin® (BASF SE, Germany).

### Methods:

The “WSP” standard methods referred to below are described in: “Standard Test Methods for the Nonwovens Industry”, 2005 edition, jointly published by “Worldwide Strategic Partners” EDANA (European Disposables and Nonwovens Association, Avenue Eugene Plasky, 157, 1030 Brussels, Belgium, www.edana.org) and INDA (Association of the Nonwoven Fabrics Industry, 1100 Crescent Green, Suite 115, Cary, North Carolina 27518, U.S.A., www.inda.org). This publication is available from EDANA or INDA.

The measurements should be carried out, unless otherwise stated, at an ambient temperature of 23±2° C. and a relative humidity of 50±10%. The water-absorbing material is thoroughly mixed through before measurement.

### Centrifuge Retention Capacity (CRC)

Centrifuge Retention Capacity is determined by Standard Test WSP 241.2 “Fluid Retention capacity in Saline, after Centrifugation”. In the following examples, however, the actual sample having the particle size distribution reported in the example was measured.

Absorbency under Load (AUL)

Absorbency under Load is determined by Standard Test WSP 242.2“Absorption under pressure, Gravimetric Determination”. In the following examples, however, the actual sample having the particle size distribution reported in the example was measured.

### Moisture Content

Water (or Moisture) Content is determined using Standard Test WSP 230.2 “Mass Loss upon Heating”.

### Fixed Height Absorption (FHA)

The FHA is a method to determine the ability of a swollen gel layer to transport fluid by wicking. It is executed and evaluated as described in WO 2009/016054 A2.

### Saline Flow Conductivity

The method to determine the permeability of a swollen hydrogel layer is the “Saline Flow Conductivity” also known as “Gel Layer Permeability” is described in WO 2009/016054 A2.

### 16 h Extractables

The level of extractable constituents in the water-absorbing polymeric particles is determined by Standard Test WSP 270.2 “Extractables”.

### pH Value

The pH of the water-absorbing material is determined by Standard Test WSP 200.2 “pH of Polyacrylate (PA) Powders”.

### Free Swell Rate (FSR)

The method is described in WO 2009/016054 A2.

### Particle Size Distribution (PSD)

The PSD is determined by Standard Test WSP 220.2 “Particle Size Distribution”.

### Flow Rate (FLR)

The Flow Rate is determined by Standard Test WSP 250.2 “Flow Rate, Gravimetric Determination”.

### Apparent Bulk Density (ABD)

The bulk density is determined by Standard Test WSP 260.2 “Density, Gravimetric Determination”.

### Cylinder Centrifuge Retention Capacity (CCRC)

The method is described in WO 2006/097389.

Core-Shell Absorbency under Load (CS-AUL)

The method is described in WO 2006/097389.

### Core-Shell Saline Flow Conductivity (CS-SFC)

The method is described in WO 2006/097389.

### EXAMPLES

The examples designated as A are examples for the preparation of the base water-absorbing polymer.

The examples designated as B are preparation examples for the postcrosslinked water-absorbing polymer particles with a Centrifuge Retention Capacity (CRC) in the range from 26 to 30 g/g, an (AAP) of ≧21, a Fixed Height Absorption (FHA) of ≧21, a Saline Flow Conductivity (SFC) of ≧80, and an (FSR) of ≧0.10 according to the invention.

The examples designated with C describe the vacuum and optional plasma treatment.

### Example A1

### Preparation of Base Water-Absorbing Polymer

A Lodige VT 5R-MK plowshare kneader with 5 l capacity was charged with 206.5 g of deionized water, 271.6 g of acrylic acid, 2115.6 g of 37.3% by weight sodium acrylate solution (100 mol % neutralized) and also 1.288 g of a triply ethoxylated glycerol triacrylate crosslinker. This initial charge was inertized by bubbling nitrogen through it for 20 minutes. This was followed by the addition of dilute aqueous solutions of 0.618 g of sodium persulfate (dissolved in 13.9 g of water) and 0.013 g of ascorbic acid (dissolved in 10.46 g of water) to initiate the polymerization at about 20° C. After initiation, the temperature of the heating jacket was controlled to follow as close as possible (+/−0.5° C.) the reaction temperature inside the reactor. The crumbly gel ultimately obtained was then dried in a circulating air drying cabinet at 160° C. for about 3 hours.

The dried base polymer was ground and classified to 200-600 μm by sieving off over- and undersize particles.

The properties (averages) of the polymer were as follows:

Particle size distribution (average):
<200 μm: 1.8% by weight
200-500 μm: 55.5% by weight
500-600 μm: 37.1% by weight
>600 μm: 5.5% by weight
CRC=35.6 g/g
AUL 0.3 psi=17.9 g/g
16 h extractables=12.7% by weight
pH=5.9

### Example B1

### Surface Treatment of the Base Water-Absorbing Polymer

The base polymer being used here was prepared on the production scale in a batch kneader and corresponds to the base polymer according to example A1. It is characterized by the following data:

CRC=36 g/g

AUL 0.3 psi=16 g/g

PSD: >600 μm=6%
>500 μm=37%
>300 μm=44%
>300 μm=15%

In a pilot plant, this base polymer was sprayed with two surface postcrosslinking solutions and then heat-treated. The two solutions were sprayed on simultaneously in a Schuggi® Flexomix 100 D mixer with gravimetric dosage of the base polymer and continuous mass flow-controlled liquid dosage via two two-substance nozzles. The postcrosslinker solution I was sprayed on via a fine liquid nozzle (type J-2850-SS+gas nozzle J-73328-SS), which is arranged offset by 90° (based on the base polymer introduction site), while the postcrosslinker solution (or dispersion) II was sprayed on via a coarser liquid nozzle (type J-60100-SS+gas nozzle J-125328-SS), which is arranged offset by 270° (based on the base polymer introduction site). The nozzle types used are produced by Spraying Systems Deutschland GmbH. The spray gas used was nitrogen with a pressure of in each case 2 bar.

All quantitative data which follow are based on base polymer used. The postcrosslinker solution I comprised 0.83% by weight of water, 0.87% by weight of isopropanol, 0.05% by weight of 2-hydroxyethyloxazolidinone, 0.05% by weight of propanediol-1,3 and 0.008% by weight of Span 20 (sorbitan monolaurate). The postcrosslinker solution (or suspension) II comprised 0.3% by weight of water, 1.2% by weight of aluminum lactate solution 25% (Lohtragon® AL 250 from Dr. Paul Lohmann GmbH, Germany) and 0.3% by weight of tricalcium phosphate C53-80 (Chemische Fabrik Budenheim KG, Germany). The tricalcium phosphate was first dispersed in water and the aluminum lactate solution was dispersed with a high-speed stirrer (Turrax) and kept homogeneous by stirring in an appropriate reservoir vessel. The two postcrosslinker solutions were sprayed onto the base polymer, solution I at a rate of 1.446 kg/h, solution II at a rate of 1.44 kg/h, which corresponds to a loading of the base polymer of from 3.6 to 3.7% by weight based on the polymer. The moist polymer was transferred directly falling out of the Schuggi mixer into a NARA® NPD 1.6 W reaction drier. The base polymer throughput rate was approx. 80 kg/h and the product temperature of the steam-heated drier at the drier outlet was approx. 193° C. The setting of the drier with an inclination in the direction of the outlet of 3°, a weir height of approx. 64 mm, which corresponds to a fill level of approx. 95%, and a rotation speed of the shaft of approx. 14 rpm established a mean residence time of the product in the drier of approx. 35 minutes. Connected downstream of the drier was a cooler which cooled the product rapidly to approx. 50° C. Before being transferred to a transport container, the polymer was also passed through a screening machine equipped with two screening decks (150 μm/710 μm), and approx. 10% polymer (based on base polymer used) was removed predominantly as coarse material.

The resulting end product had the following properties (mean from 30 samples):
CRC=27.6 g/g
AUL 0.7 psi=24.5 g/g
SFC=129×10⁻⁷ cm³ sg⁻¹
FSR=0.2 g/g s
FHA=22 g/g
FLR=9.5 g/s
ABD=0.65 g/cm³
PSD: >600 μm=1%
   >500 μm=21%
   >300 μm=46%
   >150 μm=31%
   <150 μm=1%

### Example C1

### Vacuum and Plasma Treatment

A sample of the product from example B1 described was plasma-treated in a “Pico LFUHP D” laboratory plasma unit from Diener Electronic GmbH+Co. KG (TalstraRe 5, 72202 Nagold, Germany). To this end, at ambient temperature (23±2° C.), a 20 g sample was filled into a glass bottle which formed part of the equipment provided and was clamped unsealed in the plasma unit. The vacuum pump belonging to the plasma unit was switched on and run at maximum power. At a pressure of 0.6 mbar, air as the working gas with a gas flow of 400 ml/minute was switched on. Once the pressure had fluctuated and again reached a constant value (approx. 5 minutes), the plasma generator was switched on and run at 100% power. In the working state, the polymer-filled glass bottle is subject to a slow rotation which is predetermined by the unit and is not variable. Under these conditions, the sample was treated for 30 minutes, in the course of which the polymer was heated. Thereafter, the plasma generator was switched off and the sample was vented and the pressure was equalized to standard pressure with air. The following FHA and FSR values were determined before the plasma treatment of product B1 and after the vacuum and plasma treatment (product C1) using samples:

| | FHA | FSR |
|---|---|---|
| Example | [g/g] | [g/g/s] |
| B1 | 22.4 | 0.20 |
| C1 | 24.8 | 0.25 |

### Example B2

### Coating of Polymer as of Example A1

Preparation of the coating suspension (I) was as follows:

| | | |
|---|---|---|
| 23.65 | g | of water, |
| 6.00 | g | of tricalcium phosphate (C53-80 from Cfb |
| | | BUDENHEIM, Germany), |
| 12.55 | g | of isopropanol, |
| 0.84 | g | of 1,3-propanediol, |
| 0.85 | g | of N-(2-hydroxyethyl)-2-oxazolidinone, |
| 0.036 | g | of sorbitan monolaurate (ALDRICH) and |
| 1.14 | g | of a 10.5% by weight aqueous solution of |
| | | polyvinylformamide/vinylamine (molar ratio 1:1) |
| | | (Luredur ® PR 8097 from BASF SE, Germany) |

The components were charged in a beaker and homogenized for about one minute with an Ultraturrax (IKA Type TP18/10, Shaft: S25N-10G).

Preparation of the hydrophobic coating dispersion (II) was as follows:

3.16 g of a 38% by weight aqueous anionic, aliphatic polyurethane dispersion from BASF AG, Germany, based on polyetherols, pH ˜8 (Astacin® Finish PUMN TF) and 6.97 g of water.

The components were charged in a beaker and stirred for few minutes with standard lab stirring equipment until a homogeneous dispersion was obtained.

A Lödige plowshare mixer of capacity 5 l was charged at room temperature with 1200 g of base polymer according to example A1. At a speed of 200 rpm 45.06 g of the coating suspension (I) and 10.13 g of the coating dispersion (II) were sprayed independently but in parallel onto the polymer particles within about 10 minutes, each via a 2-substance nozzle while using nitrogen of pressure 1 bar as atomizing gas and using a peristaltic pump for feeding the coating suspension.

Directly after coating was finished the coated polymer particles were transferred into a second, already preheated Lödige plowshare mixer of capacity 5 I (thermostat temperature 245° C.) and heated up to product temperature 190° C. for 35 minutes with nitrogen inertization. With increasing product temperature, coming closer to target temperature the thermostat set-temperature was reduced to 215° C. and kept unchanged until end of the run. To eliminate possible formation of agglomerates the surface crosslinked polymer particles were sieved on completion of heat treatment and before characterization over a 600 μm screen.

The coated material was subsequently tested for performance.

SFC: 207×10⁻⁷ [cm³s/g]

### AU L: 23.0 g/g

### CRC: 28.2 g/g

FSR: 0.21 g/g/s

### FHA: 17 g/g

### Example C2

A sample of the product of example B2 described was treated with plasma entirely analogously to example C1. The following values were measured:

| | FHA | FSR |
|---|---|---|
| Example | [g/g] | [g/g/s] |
| B2 | 17.0 | 0.20 |
| C2 | 24.6 | 0.21 |

### Example B3

Coating of ASAP 510 Z (commercial product) with Astacin PUMN TF:

The 150-500 μm fraction was sieved out of the commercially available product ASAP 510 Z (BASF SE) having the following properties and was then coated with Astacin PUMN TF according to the procedure below:

ASAP 510 Z (properties of the 150-500 μm fraction only):

CCRC=25.4 g/g

CS-AUL 0.7 psi=23.9 g/g

CS-SFC=55×10⁻⁷ [cm³s/g]

For the coating a Wurster laboratory coater from Waldner was used without using a Wurster tube. 2000 g per batch of super absorbent polymer ASAP 510 Z (commercially available product of BASF SE) of the particle distribution 150-500 μm were used. The Wurster apparatus was cone-shaped with a lower diameter at the bottom of 150 mm expanding to an upper diameter of 300 mm, the carrier gas was nitrogen having a temperature of 30° C., and the gas flow speed was 1.4 m/s at a pressure of 2 bar. The plate of the apparatus had drill holes of diameter 1.5 mm and an effective open cross-section for through-air-flow of 4.2%.

The coating agents (polymer dispersion: Polyurethane Astacin PUMN TF, BASF SE; deagglomeration agent: Silica sol LEVASIL® 50, H.C. Starck GmbH) have been atomized and spray-coated using a nitrogen-driven two-material nozzle from Schlick (Germany) operated in bottom spray mode, opening diameter 1.2 mm, the nitrogen temperature being 25° C. The coating agents have been sprayed each as a 20% by weight aqueous dispersion at a temperature of 23° C. First the aqueous polymer dispersion has been sprayed on, followed immediately thereafter by the aqueous dispersion of the deagglomeration aid.

Based on the weight of the absorbent polymer 2.0 wt. % (calculated as 100% solid) Astacin PUMN TF and 0.5 wt. % (calculated as 100% solid) Levasil® 50 have been used for coating. Spraying time has been 30 minutes for the polymer dispersion and 5 minutes for the deagglomeration aid.

The coated material was subsequently removed and has been transferred into a second laboratory fluidized bed dryer in which it has been held and heat treated at 168-170° C. (product temp.) for 40 minutes under nitrogen flow (gas inlet temp. about 30° C. higher than product temp.). Thereafter it was immediately poured onto a stainless steel tray and allowed to cool down to room temperature. Lumps have been removed from the coated material by coarse sieving over a 1000 μm screen and the coated material was subsequently tested for performance.

CS-SFC: 452×10⁻⁷ [cm³s/g]

CS-AU L: 22.7 g/g

CCRC (1 g/4 hrs): 24.9 g/g

CCRC (1 g/30′): 23.3 g/g

FSR: 0.03 g/g/s

FHA: 3.8 g/g

### Example C3

### Vacuum and Plasma Treatment

A sample of the product from B3 described above was treated with plasma entirely analogously to example C1. The following values were determined for the starting substance B3 and the end product C3. Aging tests were carried out with the end product C3. A sample of the end product C3 was stored in each case at room temperature and at 60° C., and the FHA and FSR were each determined using a sample at intervals of three months.

| | FHA | FSR |
|---|---|---|
| Example | (g/g) | (g/g/s) |
| before vacuum and plasma treatment (B3) | 3.8 | 0.03 |
| after vacuum and plasma treatment (C3) | 6.7 | 0.10 |
| after approx. 3 months of storage, sample | 6.7 | 0.10 |
| stored at RT | | |
| after approx. 3 months of storage, sample | 6.1 | 0.10 |
| stored at 60° C. | | |
| after approx. 6 months of storage, sample | 6.1 | 0.10 |
| stored at RT | | |
| after approx. 6 months of storage, sample | 6.0 | 0.10 |
| stored at 60° C. | | |

### Preparation Examples B4-11

Entirely analogously to preparation example B3, the following polymer dispersions were sprayed onto ASAP 510 Z (150-500 μm) instead of the 2.0 wt.-% of Astacin PUMN TF:
Example B4: Blend of 2.0% by weight (calculated as solids content 100 based on SAP **) of Astacin® PUMN TF+1.0% by weight of Corial® Binder IF *) (calculated as solids content 100 based on SAP)
Example B5: Blend of 0.5% by weight (calculated as solids content 100 based on SAP) Astacin® PUMN TF+0.25% by weight of Corial® Binder IF *) (calculated as solids content 100 based on SAP)
Example B6: Blend of 0.25% by weight (calculated as solids content 100 based on SAP) Astacin® PUMN TF+0.125% by weight of Corial® Binder IF *) (calculated as solids content 100 based on SAP)
Example B7: Blend of 0.125% by weight (calculated as solids content 100 based on SAP) Astacin® PUMN TF+0.5% by weight of Corial® Binder IF *) (calculated as solids content 100 based on SAP)
Example B8: 0.5% by weight (calculated as solids content 100 based on SAP) of Corial® Binder IF *)
Example B9: 1.0% by weight (calculated as solids content 100 based on SAP) of Corial® Binder IF *)
Example B10: 2.0% by weight (calculated as solids content 100 based on SAP) of Corial® Binder IF*)
Example B11: 1.5% by weight of Astacin® PUMN-TF (calculated as solids content 100 based on the particles of example A1)+2.5% by weight of Polyethylenglycol 400 (based on the solid content of Astacin PUMN-TF) coated onto the particles of example A1, via the process set out under example B2.
*): Corial® Binder IF is an aqueous copolymer dispersion from BASF AG, Germany, based on acrylic ester, acrylonitrile, (meth)acrylamide and acrylic acid with a solids content of 40% by weight.
**): SAP stands for water absorbing polymeric particle

### Examples C4-C10

### Vacuum and Plasma Treatment

A sample of each of the end products from preparation examples B4-10 was treated with vacuum and plasma entirely analogously to example C1. The following values for the end products were measured:

| | FHA | FSR |
|---|---|---|
| Example | [g/g] | [g/g] |
| B4 | 2.9 | 0.045 |
| C4 | 5.8 | 0.096 |
| B5 | 3.5 | 0.085 |
| C5 | 8.8 | 0.162 |
| B6 | 4.0 | 0.081 |
| C6 | 10.6 | 0.182 |
| B7 | 4.2 | 0.073 |
| C7 | 13.6 | 0.172 |
| B8 | 3.9 | 0.094 |
| C8 | 8.1 | 0.190 |
| B9 | 3.7 | 0.101 |
| C9 | 5.6 | 0.189 |
| B10 | 3.6 | 0.073 |
| C10 | 5.9 | 0.145 |

### Example C 11

### Vacuum and Plasma Treatment

A sample of the end product from preparation examples B 11 was treated with vacuum and plasma entirely analogously to example C1. The following values for the end products were measured:

| | FHA |
|---|---|
| Example | [g/g] |
| B 11 | 4.8 |
| C 11 | 9.9 |

### Preparation Example B12

The base polymer being used here was prepared on the production scale in a batch kneader and corresponds to the base polymer according to example A1, except that the monomer concentration for the polymerization was 35.5 wt.-%, Sodium Persulfate amount was 0.122 wt.-% based on total Acrylic Acid, crosslinker amount was 0.375 wt.% based on total Acrylic Acid and that instead of Ascorbic Acid it was used 0.04 wt.-% (based on total Acrylic Acid) of a reducing agent, which is a blend of 2-Hydroxy-2-sulfinatoaceticacid-Di-Na, 2-Hydroxy-2-sulfonatoaceticacid-Di-Na and Na-bisulfit and which is sold by the company BrüggemannChemical, L. Brüggemann KG, Germany under the trade name Bruggolite® FF7.

The dried base polymer was ground and classified to 150-710 μm by sieving off over- and undersize particles. It is characterized by the following data (averages):

CRC=36 g/g

AUL 0.3 psi=15 g/g

Extractables, 16 hrs=12%

PSD: >710 μm=≦1%
>600 μm=19%
>300 μm=65%
>200 μm=10%
>150 μm=4%
<150 μm=≦1%

In a pilot plant, this base polymer was at first sprayed with two surface post-crosslinking solutions and was then heat-treated. The two solutions were sprayed on simultaneously in a Schuggi® Flexomix 100 D mixer with gravimetric dosage of the base polymer and continuous mass flow-controlled liquid dosage via two two-substance nozzles. The post-crosslinker solution I was sprayed on via a fine liquid nozzle (type J-2850-SS+gas nozzle J-73328-SS), which is arranged offset by 90° (based on the base polymer introduction site), while the post-crosslinker solution (or dispersion) II was sprayed on via same liquid nozzle (type J-2850-SS+gas nozzle J-73328-SS), which is arranged offset by 270° (based on the base polymer introduction site). The nozzle types used are produced by Spraying Systems Deutschland GmbH. The spray gas used was nitrogen with a pressure of in each case 2 bar.

All quantitative data which follow are based on base polymer used. The postcrosslinker solution I comprised 0.97% by weight of isopropanol, 0.05% by weight of 2-hydroxyethyloxazolidinone, 0.05% by weight of propanediol-1,3, 0.008% by weight of Span 20 (sorbitan monolaurate) and 2.4% by weight of aluminum lactate solution 25% (Lohtragon® AL 250 from Dr. Paul Lohmann GmbH, Germany). The post-crosslinker solution (or dispersion) II comprised 0.23% by weight of water and 0.39% by weight of Astacin PUMN TF (BASF SE, Germany). The two post-crosslinker solutions were sprayed onto the base polymer, solution I at a rate of 2,782 kg/h, solution 11 at a rate of 0,496 kg/h, both at a base polymer throughput of 80 kg/h. The moist polymer was transferred directly falling out of the Schuggi mixer into a NARA® NPD 1.6 W reaction drier. The base polymer throughput rate was approx. 80 kg/h and the product temperature of the steam-heated drier at the drier outlet was approx. 196° C. The setting of the drier with an inclination in the direction of the outlet of 3°, a weir height of approx. 64 mm, which corresponds to a fill level of approx. 95%, and a rotation speed of the shaft of approx. 14 rpm established a mean residence time of the product in the drier of approx. 35 minutes. Connected downstream of the drier was a cooler which cooled the product rapidly to approx. 50° C. Before being transferred to a transport container, the polymer was also passed through a screening machine equipped with two screening decks (150 μm/710 μm), and approx. 19% polymer (based on base polymer used) was removed predominantly as coarse material.

The resulting end product had the following properties (mean from 30 samples):

CRC=27.0 g/g

AUL 0.7 psi=23.8 g/g

SFC=185×10⁻⁷ cm³ sg-1

FSR=0.2 g/g s

FHA=21 g/g

FLR=10.2 g/s

ABD=0.68 g/cm³

PSD: >710 μm=≦1%
>600 μm=14%
>300 μm=54%
>150 μm=31%
<150 μm=≦1%

### Example C12

A sample of the end product from preparation examples B 12 was treated with vacuum and plasma entirely analogously to example C1. The following values for the end products were measured:

| | FHA |
|---|---|
| Example | [g/g] |
| B12 | 21.2 |
| C12 | 23.9 |

### Examples C13-C15

For plasma treatment, the 300-600 μm particle fraction of a development product which had been prepared analogously to example B1, except without tricalcium phosphate, but had been surface treated with 0.6% by weight (based on water absorbing particles) of aluminum lactate, was used. The plasma treatment was effected as described in plasma example 1, except that the use amount of the product B1 and/or the plasma treatment time were varied, which can be discerned from the following table.

The following values were measured:

| | Amount | Plasma | | FHA | FSR |
|---|---|---|---|---|---|
| Example | of SAP | treatment time | | (g/g) | (g/g/s) |
| Before plasma | — | — | | 19.4 | 0.153 |
| treatment | | | | | |
| Product B1 | | | | | |
| C13 | 20 g | 30 | minutes | 24.4 | 0.167 |
| C14 | 20 g | 1 | minute | 23.7 | 0.161 |
| C15 | 100 g | 1 | minute | 21.6 | 0.145 |

SAP: water absorbing particles

### Examples C16-18

### Only Vacuum Treatment

For plasma treatment, the 300-600 μm particle fraction of a development product which had been prepared analogously to example B1, except without tricalcium phosphate, but had been surface treated with 0.6% by weight (based on water absorbing particles) of aluminum lactate, was used. The treatment was effected as described in plasma example C1, except that the plasma generator was not switched on. The used amount of the product B1 and the vacuum treatment time are listed in the following table.

The following values were measured:

| | Amount | Vacuum | | FHA | FSR |
|---|---|---|---|---|---|
| | of SAP | treatment time | | (g/g) | (g/g/s) |
| Before | — | — | | 19.4 | 0.153 |
| vacuum | | | | | |
| treatment | | | | | |
| C16 | 100 g | 5 | minutes | 17.8 | 0.155 |
| C17 | 100 g | 30 | minutes | 18.8 | 0.165 |
| C18 | 20 g | 30 | minutes | 16.8 | 0.167 |

SAP: water absorbing particles

### Examples C19-23

### Only Vacuum Treatment

For the vacuum treatment the same development product was been used as described in examples C13-18, but it was chosen now the particle size distribution cut 150-710 μm. Prior to the vacuum treatment water and/or a water miscible organic solvent was added to the water absorbing polymer in an amount given in the following table by weight of the water-absorbing particles. The vacuum treatment was effected as described in example plasma C1, except that the plasma generator was not switched on. The used amount of the product B1 and the vacuum treatment time are listed in the following table.

The following values were measured

| | Treatment prior | Amount of | Vacuum | FSR |
|---|---|---|---|---|
| | to vacuum | SAP | treatment time | (g/g/s) |
| Before | — | — | — | 0.152 |
| vacuum | | | | |
| treatment | | | | |
| C19 | — | 20 g | 30 minutes | 0.163 |
| Before | +2% water | — | — | 0.158 |
| vacuum | | | | |
| treatment | | | | |
| C20 | +2% water | 20 g | 30 minutes | 0.161 |
| Before | +2% Isopropanol | — | — | 0.153 |
| vacuum | | | | |
| treatment | | | | |
| C21 | +2% Isopropanol | 20 g | 30 minutes | 0.162 |
| Before | +1.4% water + 0.6% | — | — | 0.156 |
| vacuum | Isopropanol | | | |
| treatment | | | | |
| C22 | +1.4% water + 0.6% | 20 g | 30 minutes | 0.166 |
| | Isopropanol | | | |
| Before | +0.6% water + 1.4% | — | — | 0.174 |
| vacuum | Isopropanol | | | |
| treatment | | | | |
| C23 | | 20 g | 30 minutes | 0.187 |

SAP: water absorbing particles

### Examples C24-32

### Only Vacuum Treatment

For the vacuum treatment with reduced vacuum the same development product might be used as described in examples C17-21 in the same PSD-cut 150-710 μm. The vacuum treatment should be effected as described in example plasma C1, except that different vacuum levels should be hold and that the plasma generator should not be switched on.

The following amounts, vacuum levels and time should be chosen:

| | Amount | Vacuum | Vacuum | |
|---|---|---|---|---|
| | of SAP | level | treatment time | |
| Before | — | — | — | |
| vacuum | | | | |
| treatment | | | | |
| C24 | 20 g | 1 mbar | 30 | minutes |
| C25 | 20 g | 1 mbar | 1 | minute |
| C26 | 20 g | 100 mbar | 30 | minutes |
| C27 | 20 g | 250 mbar | 30 | minutes |
| C28 | 20 g | 250 mbar | 10 | minutes |
| C29 | 20 g | 250 mbar | 1 | minute |
| C30 | 20 g | 500 mbar | 30 | minutes |
| C31 | 20 g | 700 mbar | 30 | minutes |

SAP: water absorbing particles

### Comparative Example B13 with Aerosil 200

The sample B12 as described above was treated with Aerosil 200 (as available from for example BASF, Germany), a hydrophilic silica-based coating agent, by applying this as an aqueous spray-on dispersion, to obtain a 1% by weight of the A1 particles of Aerosil 200 coating. Sample B13 with this Aerosil 200 coating showed a FHA value of 17.4 g/g, which was significantly less than the FHA of the surface treated example C12 (23.9 g/g).

US Provisional/Patent Application No. 61/354,267, eingereicht am 14.06.2010, ist eingefügt in die vorliegende Anmeldung durch Literaturhinweis. Im Hinblick auf die oben genannten Lehren sind zahlreiche Änderungen and Abweichungen von der vorliegenden Erfindung möglich. Mann kann deshalb davon ausgehen, dass die Erfindung, im Rahmen der beigefügten Ansprüche, anders als hierin spezifisch beschrieben, ausgeführt werden kann.

1. A method of producing water-absorbing particles comprising the steps of
a) obtaining post-crosslinked and optionally coated water-absorbing polymeric particles;
b) exposing said particles of step a) to a vacuum-treatment, at a pressure of from 0.0001 mbar to 700 mbar; and
c) optionally exposing said particles of step b) to a plasma-treatment.

2. The method of claim 1 comprising the steps of vacuum-treatment and plasma treatment.

3. The method of claim 1, wherein the water-absorbing particles are obtained by polymerization of a monomer solution comprising
i) at least one ethylenically unsaturated acid functional monomer,
ii) at least one ethylenically unsaturated crosslinker,
iii) if appropriate, one or more ethylenically and/or allylically unsaturated monomer copolymerizable with i),
iv) if appropriate one or more water-soluble polymer grafted wholly or partly with the monomers i), ii) and if appropriate iii),
v) if appropriate in the presence of a non radical crosslinking agent, having in a single molecule two or more functional groups each of which allows formation of an ester or an amide bond by reaction with carboxyl groups,
to obtain base water-absorbing polymer particles which are subsequently surface modified by postcrosslinking and optionally by at least one surface modifying agent.

4. The method of claim 1 wherein the post-crosslinked water-absorbing polymeric particles are obtained by surface modifying the base water-absorbing polymer with a postcrosslinker and at least one water soluble polyvalent metal salt.

5. The method of claim 1 wherein the post-crosslinked water-absorbing polymeric particles are obtained by surface modifying ef the base water-absorbing polymer with a postcrosslinker and at least one water-insoluble metal phosphate.

6. The method of claim 1 wherein the post-crosslinked water-absorbing polymeric particles are obtained by surface modifying the base water-absorbing polymer with a postcrosslinker and at least one film forming polymer.

7. The method of claim 6 wherein the film forming polymer has a minimum film forming temperature above −10° C.

8. The method of claim 1 wherein the water-absorbing particles are treated with 0.1 to 5 weight-% water and/or a water miscible organic solvent prior to vacuum treatment.

9. The method of claim 1 where the vacuum-treatment is at a pressure in the range of 0.0001 mbar to 20 mbar.

10. Method The method of claim 1 wherein the vacuum-treatment is over a period of 0.1 seconds to 30 minutes.

11. A method of producing water-absorbing particles comprising a plasma-treatment of post-crosslinked water-absorbing polymeric particles.

12. The method of claim 11 wherein the post-crosslinked water-absorbing polymeric particles are obtained by surface modifying the base water-absorbing polymer with a postcrosslinker and at least one film forming polymer.

13. Water-absorbing polymeric particles obtained by the method according to claim 1.

14. The method of claim 11 wherein the plasma treatment is performed under ambient atmospheric pressure.

15. Water-absorbing polymeric particles obtained by the method according to claim 11.
